(19) United States
(12) Patent Application Publication
(10) Pub. No.: US 2025/0088330 A1
(43) Pub. Date: Mar. 13, 2025

(54) RESOURCE GROUPING INFORMATION INDICATION FOR TIME-DOMAIN CHANNEL REPORTING AND RESOURCE SELECTION

(71) Applicant: QUALCOMM Incorporated, San Diego, CA (US)

(72) Inventors: Min HUANG, Beijing (CN); Jing DAI, Beijing (CN); Liangming WU, Beijing (CN); Wei XI, Beijing (CN); Chao WEI, Beijing (CN); Hao XU, Beijing (CN)

(21) Appl. No.: 18/727,996

(22) PCT Filed: Mar. 31, 2022
(86) PCT No.: PCT/CN2022/084373

§ 371 Date: Jul. 10, 2024

(51) Int. Cl. H04L 5/00; H04W 24/10; H04W 72/231

(52) U.S. Cl. CPC H04L 5/0051; H04W 24/10; H04W 72/231

(57) ABSTRACT

Methods, systems, and devices for wireless communication are described. A user equipment (UE) may transmit a sounding reference signal (SRS) in multiple slots. A network entity may determine precoding weights in three domains based on the SRS and output reference signals that are precoded based on the precoding weights. The network entity may output control signaling that indicates reference signal resource grouping information that the UE is to use for channel estimations. The reference signal resource grouping information may specify whether the ports in one group are precoded with identical or different spatial, frequency, and time domain weights. A UE may receive the precoded reference signals and the grouping information and report estimated channel metrics and an indication of selected ports per group to the network entity. The network entity may determine precoding in three domains for subsequent downlink communications.

### CROSS REFERENCE

The present application is a 371 national phase filing of International PCT Application No. PCT/CN2022/084373 by HUANG et al., entitled “RESOURCE GROUPING INFORMATION INDICATION FOR TIME-DOMAIN CHANNEL REPORTING AND RESOURCE SELECTION,” filed Mar. 31, 2022, which is assigned to the assignee hereof, and which is expressly incorporated by reference in its entirety herein.

### FIELD OF TECHNOLOGY

The following relates to wireless communication, including resource grouping information indication for time-domain channel reporting and resource selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

The described techniques relate to improved methods, systems, devices, and apparatuses that support resource grouping information indication for time-domain channel reporting and resource selection. Generally, the described techniques provide for channel state information (CSI) reporting in mobile environments. At high speeds, a variance between a first CSI and a second subsequent CSI may be large. To compensate for the large variance, a network entity may determine precoding for future transmissions based on one or more reference signals. For example, a user equipment (UE) may transmit a sounding reference signal (SRS) in multiple slots. The network entity may determine precoding weights in three domains (e.g., time, frequency, spatial) based on the SRS and output reference signals that are precoded based on the precoding weights. The network entity may output control signaling that indicates reference signal resource grouping information that the UE is to use for channel estimations. In some cases, the reference signal resource grouping information may include multiple groups of reference signal resources (e.g., multiple groups of ports) and an indication of precoding information for each group. The precoding information may specify whether the ports in one group are precoded with identical or different spatial, frequency, and time domain weights. A UE may receive the precoded reference signals and the grouping information and estimate channel metrics corresponding to one or more of the indicated groups. The UE may report the estimated channel metrics and an indication of selected ports per group to the network entity. The network entity may determine precoding in three domains for subsequent downlink communications based on the reported channel metric and port indications.

A method for wireless communication at a UE is described. The method may include receiving two or more reference signals that are precoded in three domains, where the two or more reference signals are received using respective reference signal resources, receiving control signaling indicating reference signal resource grouping information, where the reference signal resource grouping information specifies at least one group of reference signal resources and precoding information in the three domains for the at least one group, and transmitting an indication of a channel metric corresponding to at least two reference signal resources, where the channel metric is determined based on measuring reference signals and the reference signal resource grouping information.

An apparatus for wireless communication at a UE is described. The apparatus may include a processor, memory coupled with the processor, and instructions stored in the memory. The instructions may be executable by the processor to cause the apparatus to receive two or more reference signals that are precoded in three domains, where the two or more reference signals are received using respective reference signal resources, receive control signaling indicating reference signal resource grouping information, where the reference signal resource grouping information specifies at least one group of reference signal resources and precoding information in the three domains for the at least one group, and transmit an indication of a channel metric corresponding to at least two reference signal resources, where the channel metric is determined based on measuring reference signals and the reference signal resource grouping information.

Another apparatus for wireless communication at a UE is described. The apparatus may include means for receiving two or more reference signals that are precoded in three domains, where the two or more reference signals are received using respective reference signal resources, means for receiving control signaling indicating reference signal resource grouping information, where the reference signal resource grouping information specifies at least one group of reference signal resources and precoding information in the three domains for the at least one group, and means for transmitting an indication of a channel metric corresponding to at least two reference signal resources, where the channel metric is determined based on measuring reference signals and the reference signal resource grouping information.

A non-transitory computer-readable medium storing code for wireless communication at a UE is described. The code may include instructions executable by a processor to receive two or more reference signals that are precoded in three domains, where the two or more reference signals are received using respective reference signal resources, receive control signaling indicating reference signal resource grouping information, where the reference signal resource grouping information specifies at least one group of reference signal resources and precoding information in the three domains for the at least one group, and transmit an indication of a channel metric corresponding to at least two reference signal resources, where the channel metric is determined based on measuring reference signals and the reference signal resource grouping information.

In some examples of the method, apparatuses, and non-transitory computer-readable medium described herein, receiving the control signaling may include operations, features, means, or instructions for receiving the precoding information that indicates that the at least one group of reference signal resources may be precoded with a same precoding weight in one or more domains of the three domains, a different precoding weight in the one or more domains, or a combination thereof.

In some examples of the method, apparatuses, and non-transitory computer-readable medium described herein, receiving the control signaling may include operations, features, means, or instructions for receiving an indication of a group type for the at least one group, where the indicated group type may be mapped to the precoding information and receiving a radio resource control message, a medium access control layer control element, a downlink control information message, or a combination thereof, that indicates the reference signal resource grouping information.

Some examples of the method, apparatuses, and non-transitory computer-readable medium described herein may further include operations, features, means, or instructions for selecting the at least two reference signal resources of the at least one group, where the channel metric may be based on measuring reference signals of the at least two reference signal resources and transmitting, with the indication of the channel metric, an indication of the at least two reference signal resources.

In some examples of the method, apparatuses, and non-transitory computer-readable medium described herein, the indication of the at least two reference signal resources includes an index corresponding to a port for each of the at least two reference signal resources.

In some examples of the method, apparatuses, and non-transitory computer-readable medium described herein, transmitting the indication of the channel metric may include operations, features, means, or instructions for transmitting an indication of a reference signal resource coefficient corresponding to the at least two reference signal resources of the at least one group.

Some examples of the method, apparatuses, and non-transitory computer-readable medium described herein may further include operations, features, means, or instructions for transmitting an indication of the precoding information corresponding to the at least one group and the channel metric.

In some examples of the method, apparatuses, and non-transitory computer-readable medium described herein, transmitting the indication of the precoding information may include operations, features, means, or instructions for transmitting an indication of a group type of the at least one group, where the group type may be mapped to the precoding information.

In some examples of the method, apparatuses, and non-transitory computer-readable medium described herein, receiving the control signaling may include operations, features, means, or instructions for receiving the control signaling indicating the reference signal resource grouping information that specifies a first group of reference signal resources and first precoding information in the three domains for the first group and a second group of reference signal resources and second precoding information in the three domains for the second group.

In some examples of the method, apparatuses, and non-transitory computer-readable medium described herein, transmitting the indication of the channel metric may include operations, features, means, or instructions for transmitting the indication of the channel metric for the first group, where the channel metric may be determined based on measuring the reference signals for one or more first reference signal resources of the first group and transmitting the indication of the channel metric for the second group, where the channel metric may be determined based on measuring the reference signals for one or more second reference signal resources of the second group.

Some examples of the method, apparatuses, and non-transitory computer-readable medium described herein may further include operations, features, means, or instructions for transmitting an indication of the one or more first reference signal resources selected for the first group and transmitting an indication of the one or more second reference signal resources selected for the second group.

Some examples of the method, apparatuses, and non-transitory computer-readable medium described herein may further include operations, features, means, or instructions for sounding one or more SRS resources during a set of multiple first occasions of a first period that precedes and corresponds to a second period including second occasions during which the two or more reference signals may be received, where the two or more reference signals may be precoded based on the one or more SRS resources and the reference signal resource grouping information may be based on the one or more SRS resources.

In some examples of the method, apparatuses, and non-transitory computer-readable medium described herein, the three domains include a time domain, a frequency domain, and a spatial domain and the two or more reference signals include CSI reference signals, tracking reference signals (TRSs), or a combination thereof.

Some examples of the method, apparatuses, and non-transitory computer-readable medium described herein may further include operations, features, means, or instructions for receiving a downlink transmission that may be precoded in the three domains based on the indication of the channel metric, where the downlink transmission may be a downlink shared channel transmission, a downlink control channel transmission, a reference signal transmission, or a combination thereof.

Some examples of the method, apparatuses, and non-transitory computer-readable medium described herein may further include operations, features, means, or instructions for estimating a channel matrix for the at least one group based on measuring the reference signals of the at least one group, determining optimal coefficient vectors using a minimum time variance factor and a maximum power based on the channel matrix, and determining at least channel coefficient for the at least one group.

A method for wireless communication at a network entity is described. The method may include transmitting two or more reference signals that are precoded in three domains, where the two or more reference signals are transmitted using respective reference signal resources, transmitting control signaling indicating reference signal resource grouping information, where the reference signal resource grouping information specifies at least one group of reference signal resources and precoding information in the three domains for the at least one group, and receiving, based on transmitting the two or more reference signals and the reference signal resource grouping information, an indication of a channel metric corresponding to at least two reference signal resources.

An apparatus for wireless communication at a network entity is described. The apparatus may include a processor, memory coupled with the processor, and instructions stored in the memory. The instructions may be executable by the processor to cause the apparatus to transmit two or more reference signals that are precoded in three domains, where the two or more reference signals are transmitted using respective reference signal resources, transmit control signaling indicating reference signal resource grouping information, where the reference signal resource grouping information specifies at least one group of reference signal resources and precoding information in the three domains for the at least one group, and receive, based on transmitting the two or more reference signals and the reference signal resource grouping information, an indication of a channel metric corresponding to at least two reference signal resources.

Another apparatus for wireless communication at a network entity is described. The apparatus may include means for transmitting two or more reference signals that are precoded in three domains, where the two or more reference signals are transmitted using respective reference signal resources, means for transmitting control signaling indicating reference signal resource grouping information, where the reference signal resource grouping information specifies at least one group of reference signal resources and precoding information in the three domains for the at least one group, and means for receiving, based on transmitting the two or more reference signals and the reference signal resource grouping information, an indication of a channel metric corresponding to at least two reference signal resources.

A non-transitory computer-readable medium storing code for wireless communication at a network entity is described. The code may include instructions executable by a processor to transmit two or more reference signals that are precoded in three domains, where the two or more reference signals are transmitted using respective reference signal resources, transmit control signaling indicating reference signal resource grouping information, where the reference signal resource grouping information specifies at least one group of reference signal resources and precoding information in the three domains for the at least one group, and receive, based on transmitting the two or more reference signals and the reference signal resource grouping information, an indication of a channel metric corresponding to at least two reference signal resources.

In some examples of the method, apparatuses, and non-transitory computer-readable medium described herein, transmitting the control signaling may include operations, features, means, or instructions for transmitting the precoding information that indicates that the at least one group of reference signal resources may be precoded with a same precoding weight in one or more domains of the three domains, a different precoding weight in the one or more domains, or a combination thereof.

In some examples of the method, apparatuses, and non-transitory computer-readable medium described herein, transmitting the control signaling may include operations, features, means, or instructions for transmitting an indication of a group type for the at least one group, where the indicated group type may be mapped to the precoding information and transmitting a radio resource control message, a medium access control layer control element, a downlink control information message, or a combination thereof, that indicates the reference signal resource grouping information.

Some examples of the method, apparatuses, and non-transitory computer-readable medium described herein may further include operations, features, means, or instructions for receiving, with the indication of the channel metric, an indication of the at least two reference signal resources that were used to determine the channel metric.

In some examples of the method, apparatuses, and non-transitory computer-readable medium described herein, the indication of the at least two reference signal resources includes an index corresponding to a port for each of the at least two reference signal resources.

In some examples of the method, apparatuses, and non-transitory computer-readable medium described herein, receiving the indication of the channel metric may include operations, features, means, or instructions for receiving an indication of a reference signal resource coefficient corresponding to the at least two reference signal resources of the at least one group.

In some examples of the method, apparatuses, and non-transitory computer-readable medium described herein, transmitting the control signaling may include operations, features, means, or instructions for transmitting the control signaling indicating the reference signal resource grouping information that specifies a first group of reference signal resources and first precoding information in the three domains for the first group and a second group of reference signal resources and second precoding information in the three domains for the second group.

In some examples of the method, apparatuses, and non-transitory computer-readable medium described herein, receiving the indication of the channel metric may include operations, features, means, or instructions for receiving the indication of the channel metric for the first group and receiving the indication of the channel metric for the second group.

Some examples of the method, apparatuses, and non-transitory computer-readable medium described herein may further include operations, features, means, or instructions for receiving an indication of one or more first reference signal resources selected for the first group and receiving an indication of one or more second reference signal resources selected for the second group.

Some examples of the method, apparatuses, and non-transitory computer-readable medium described herein may further include operations, features, means, or instructions for receiving one or more SRSs during a set of multiple first occasions of a first period that precedes and corresponds to a second period including second periods during which the two or more reference signals may be transmitted, where the two or more reference signals may be precoded based on the received one or more SRSs.

Some examples of the method, apparatuses, and non-transitory computer-readable medium described herein may further include operations, features, means, or instructions for deriving a channel matrix for each transmission time interval of a set of transmission time intervals and for a number of subbands based on the one or more SRSs, estimating a set of doppler frequency values using the channel matrix for each transmission time interval. where the two or more reference signals may be precoded based on the set of doppler frequency values, and determining a set of triplets based on the one or more SRSs, where each triplet includes a spatial precoding weight, a frequency precoding weight, and a time precoding weight, where the set of triplets may be applied for transmitting the at least two reference signals.

In some examples of the method, apparatuses, and non-transitory computer-readable medium described herein, the three domains include a time domain, a frequency domain, and a spatial domain and the two or more reference signals include CSI reference signals, TRSs, or a combination thereof.

Some examples of the method, apparatuses, and non-transitory computer-readable medium described herein may further include operations, features, means, or instructions for determining precoding weights for one or more transmission time intervals based on the channel metric and transmitting a downlink transmission that may be precoded in the three domains based on the channel metric, where the downlink transmission may be a downlink shared channel transmission, a downlink control channel transmission, a reference signal transmission, or a combination thereof.

### BRIEF DESCRIPTION OF THE DRAWINGS

FIG. 1 and FIG. 2 illustrate examples of a wireless communications systems that support resource grouping information indication for time-domain channel reporting and resource selection in accordance with one or more aspects of the present disclosure.

FIG. 3 illustrates an example of a timeline that supports resource grouping information indication for time-domain channel reporting and resource selection in accordance with one or more aspects of the present disclosure.

FIG. 4 illustrates an example of a process flow that supports resource grouping information indication for time-domain channel reporting and resource selection in accordance with one or more aspects of the present disclosure.

FIGS. 5 and 6 show block diagrams of devices that support resource grouping information indication for time-domain channel reporting and resource selection in accordance with one or more aspects of the present disclosure.

FIG. 7 shows a block diagram of a communications manager that supports resource grouping information indication for time-domain channel reporting and resource selection in accordance with one or more aspects of the present disclosure.

FIG. 8 shows a diagram of a system including a device that supports resource grouping information indication for time-domain channel reporting and resource selection in accordance with one or more aspects of the present disclosure.

FIGS. 9 and 10 show block diagrams of devices that support resource grouping information indication for time-domain channel reporting and resource selection in accordance with one or more aspects of the present disclosure.

FIG. 11 shows a block diagram of a communications manager that supports resource grouping information indication for time-domain channel reporting and resource selection in accordance with one or more aspects of the present disclosure.

FIG. 12 shows a diagram of a system including a device that supports resource grouping information indication for time-domain channel reporting and resource selection in accordance with one or more aspects of the present disclosure.

FIGS. 13 through 16 show flowcharts illustrating methods that support resource grouping information indication for time-domain channel reporting and resource selection in accordance with one or more aspects of the present disclosure.

### DETAILED DESCRIPTION

In some wireless communications systems, a user equipment (UE) may utilize channel state information (CSI) reporting to support communications between a network entity and the UE. For example, the network entity may determine precoding for transmissions based on the CSI report received from the UE. As UEs become increasingly mobile, the transmissions may be based on information that may vary from present conditions. For example, as the mobile UE moves from location to location, the channel conditions may vary (e.g., a path of communication between the UE and the network entity may change) according to a Doppler frequency value. When the UE moves at low speeds, the Doppler frequency value may be small and the variance between a first channel condition and a subsequent second channel condition may be small. When the UE moves at relatively higher speeds, the Doppler frequency value may be large and the variance between the channel conditions may be large. Because of the large variance between the channel conditions during higher speeds, the values of a CSI report may not be applicable for some communications, and as a result, communications may be negatively impacted.

In order to compensate for high mobility environments, the network entity may determine the precoding for the subsequent slots based on the Doppler frequency. Some wireless communications systems may support the UE transmitting a Doppler frequency report to the network entity to facilitate the precoding determination. However, relying on the Doppler reporting may result in increased signaling overhead (e.g., uplink channel information (UCI) overhead), as there may be different Doppler values for multiple paths between the UE and the network entity, decreased Doppler frequency precision due to limited signaling resources, and increased UE complexity for estimating Doppler values.

The techniques described herein provide procedures for CSI reporting in mobile environments. For example, a UE may transmit a SRS (SRS) in multiple slots. The network entity may determine precoding weights in three domains (e.g., time, frequency, spatial) based on the SRS and output reference signals that are precoded based on the precoding weights. The network entity may output control signaling that indicates reference signal resource grouping information that the UE is to use for channel estimations. In some cases, the reference signal resource grouping information may indicate multiple groups of reference signal resources (e.g., multiple groups of ports) and an indication of precoding information for each group. The precoding information may specify whether the ports in one group are precoded with identical or different spatial, frequency, and time domain weights. A UE may receive the precoded reference signals and the grouping information and estimate channel metrics corresponding to the indicated groups. The UE may report the estimated channel metrics and an indication of selected ports per group to the network entity. The network entity may determine precoding in three domains for subsequent downlink communications based on the reported channel metric and port indications.

Aspects of the disclosure are initially described in the context of wireless communications systems. Aspects are further described in the context of a timeline and a process flow. Aspects of the disclosure are further illustrated by and described with reference to apparatus diagrams, system diagrams, and flowcharts that relate to resource grouping information indication for time-domain channel reporting and resource selection.

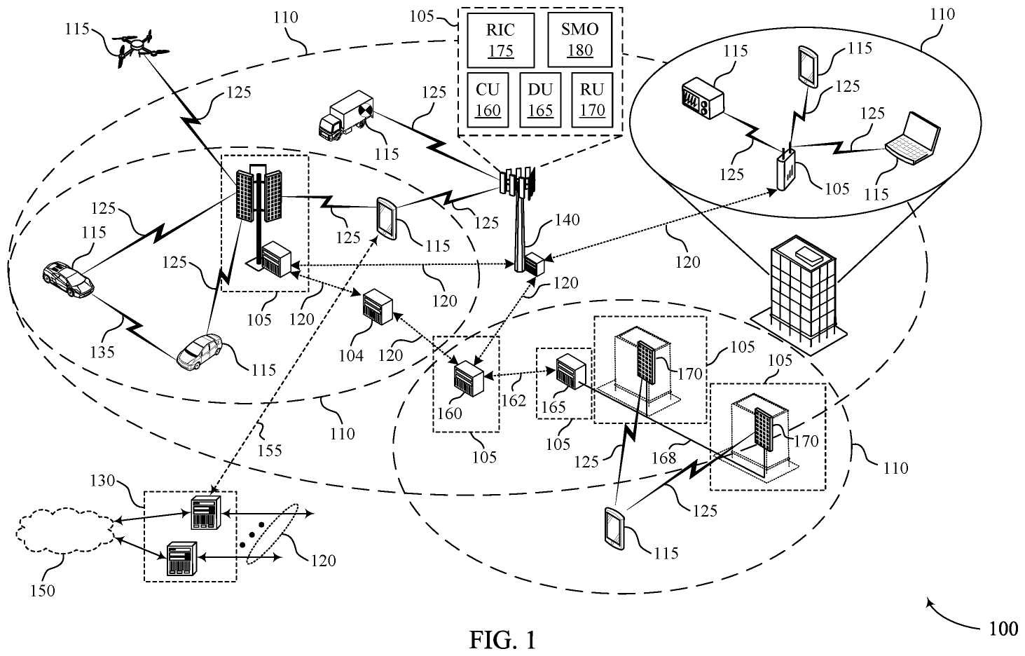

FIG. 1 illustrates an example of a wireless communications system 100 that supports resource grouping information indication for time-domain channel reporting and resource selection in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource grouping information indication for time-domain channel reporting and resource selection as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, one or more wireless devices may support enhanced time domain CSI reporting for high mobility environments. For example, the CSI reporting techniques may exploit time domain correlation with Doppler domain information to assist downlink precoding. In some cases, the techniques for time domain reporting may be applicable to a first frequency range (e.g., FR1) by refining a codebook (e.g., Type-II codebook) without modification to the spatial and frequency domain basis. Further, the techniques may support UE reporting of time domain channel properties measured via CSI reference signal (CSI-RS) for tracking.

In some wireless communications systems, a UE 115 may utilize CSI reporting to support communications between a network entity 105 and the UE 115. For example, the network entity 105 may determine precoding for transmissions based on the CSI report received from the UE 115. As UEs 115 become increasingly mobile, the channel conditions may frequency change, and as such, a CSI report may not be adequate for determining precoding for communications. For example, as the mobile UE 115 moves from location to location, the channel conditions may vary (e.g., a path of communication between the UE 115 and the network entity 105 may change) according to a Doppler frequency value. Thus, the network entity 105 may use the Doppler frequency value for downlink precoding. For example, in a high speed scenario with FDD, downlink and uplink channels may have partial reciprocity on the Doppler frequency. In such cases, an angle of departure (AoD) and an angle of arrival (AoA) associated with a downlink channel may be identical (or substantially identical) to an AoD and an AoA associated with an uplink channel. However, precoding weights (e.g., optimal weights) may be different between the downlink channel and the uplink channel due to a carrier frequency (wavelength) between the two channels being different. A Doppler frequency may be represented by Equation 1:

$${f}_{Dmax} = \frac{v}{c} {f}_{c} \qquad Equation 1$$

where f_{Dmax} represents a max Doppler frequency, v represents a velocity, c represents the speed of light, and f_{c} represents a carrier frequency. The Doppler frequencies of the downlink channel and the uplink channel may also be different due to the carrier frequency difference.

Because of the large variance between of channel conditions during higher speeds, the values of the CSI reports may not be applicable to support communications. In order to compensate for the large variance, after receiving the first CSI report, the network entity 105 may determine the precoding for subsequent slots based on the Doppler frequency. Some wireless communications systems may support the UE 115 transmitting a Doppler frequency report to the network entity 105 to facilitate the precoding determination. However, in some use cases, this method has drawbacks. For example, as the Doppler frequencies are different for each channel cluster or each path (e.g., when the propagation environment is full of geographically-distributed clusters) the feedback overhead of Doppler frequencies may be large. The drawbacks may also include a decreased Doppler frequency precision due to limited bit quantization that makes the Doppler frequency precision impaired. That is, as the control signaling resources (e.g., UCI resources) may support a limited amount of bits for Doppler frequency reporting, the precision of the reported Doppler frequency may be impacted. Further, Doppler frequency reporting may result in increased UE complexity due to the CSI report calculation (e.g., for eType-II) with spatial and frequency domain precoding already being complex. Thus, adding time domain precoding weight calculation further increases UE complexity. Additionally or alternatively, Doppler frequency reporting by a UE may increase the CSI report latency and negatively impact the throughput.

The techniques described herein provide procedures for CSI reporting in mobile environments. Additionally or alternatively, the techniques may support CSI reporting in the time-domain without a UE 115 reporting the Doppler frequency value. For example, a method which relies on calculating Doppler frequency by a network entity 105 based on uplink SRS is described. A UE 115 may transmit an SRS in multiple slots. In order to cope with the issue of partial reciprocity between uplink and downlink channels, the network entity 105 may use spatial, frequency, and time (e.g., three domains) port selection to calibrate the reciprocity mismatch. The network entity 105 may determine precoding weights in three domains (e.g., time, frequency, spatial) based on the SRS and output multiple ports of three domain (spatial, frequency, and time) precoded CSI-RS to the UE 115. To improve the performance of the three domain port selection, the network entity 105 may indicate three domain port grouping information to the UE 115. With the three domain port grouping information, the UE 115 may increase port selection performance and reduce calculation complexity. In some cases, the reference signal resource grouping information may include multiple groups of reference signal resources (e.g., multiple groups of ports) and an indication of precoding information for each group. The precoding information may specify whether the ports in one group are precoded with identical or different spatial, frequency, and time domain weights. The UE 115 may receive the precoded reference signals and the grouping information and then select various ports of the multiple three domain precoded ports and feedback their combining coefficients. The UE may report the feedback and an indication of selected ports per group to the network entity 105. The network entity 105 may determine precoding in three domains for subsequent downlink communications based on the reported channel metric and port indications.

In some examples, by performing CSI reporting according to the techniques described herein, the wireless communications system 100 may benefit in various ways. For example, the three dimensional precoded port selection with port grouping information indication may have the following various benefits. A first benefit may be decreased UCI overhead based on feedback from the UE 115 lacking specific Doppler frequency values and their associations to the spatial beams and frequency beams. Additionally or alternatively, UCI signaling overhead is decreased because a UE may feedback the indexes of selected ports and a scalar coefficient value for each selected port. A second benefit may be increased Doppler frequency precision based on the value of Doppler frequency being derived by the network entity 105 (e.g., direct derivation with no UE 115 report). A third benefit may be decreased UE complexity based on the calculation to estimate Doppler frequency being performed by the network entity 105. In some cases, the port grouping information indication may enable the UE 115 to determine the relation of the precoding weights associated with the precoded reference signals (e.g., a CSI-RS, a tracking reference signal (TRS), etc.), so that the UE 115 may better determine the port selection and their coefficients.

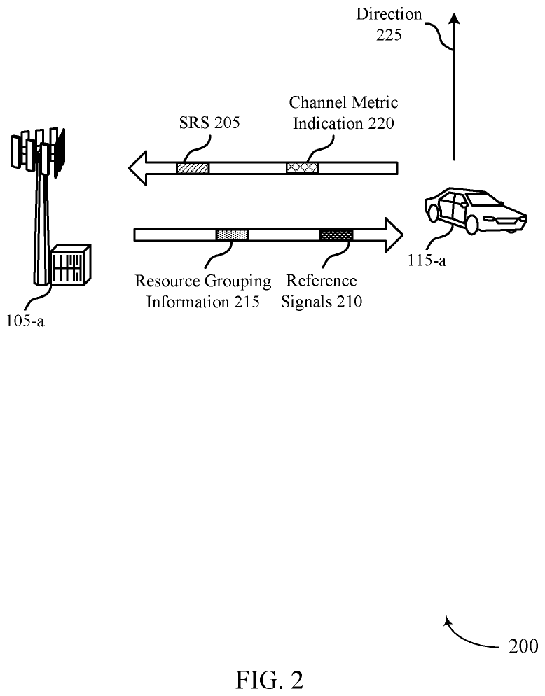

FIG. 2 illustrates an example of a wireless communications system 200 that supports resource grouping information indication for time-domain channel reporting and resource selection in accordance with one or more aspects of the present disclosure. In some examples, the wireless communications system 200 may implement aspects of the wireless communications system 100. For example, the wireless communications system 200 may include a network entity 105-a and a UE 115-a, which may be examples of a network entity 105 and a UE 115 respectively, as described herein with reference to FIG. 1. In some cases, the UE 115-a may represent examples of a mobile UE 115. In some cases, the UE 115-a may represent other types of UEs 115 different from a mobile UE 115. The network entity 105-a and the UE 115-a may be in wireless communication and support CSI reporting for channel estimation.

In some cases, the UE 115-a may travel (e.g., move, change location, etc.) in a direction 225. At some speeds, a variance between a first CSI report and channel conditions subsequent to the CSI report may be large. To compensate for the large variance, the network entity 105-a may determine time domain precoding for transmissions based on one or more reference signals.

In some examples, the UE 115-a may transmit an SRS 205 in multiple slots to the network entity 105-a. The network entity 105-a may estimate Doppler frequency using the SRS 205 transmitted in the multiple slots and determine three dimension (e.g., spatial-frequency-time) precoding weights based on the SRS 205. For example, the network entity 105-a may derive a channel matrix as {H_{n,k}}_{n=1˜N,k=1˜K} for a number of slots and a number of subbands based on the uplink SRS 205. The network entity 105-a may then estimate the Doppler frequency values based on the channel matrix. For example, for the channel matrix of each slot, {H_{n,k}}_{k=1˜K}, the network entity 105-a may calculate a wideband spatial domain precoding matrix W₁=[w_{spatial,1}, w_{spatial,2}, . . . , w_{spatial,N}_{ₜᵢₘₑ}], a frequency domain precoding matrix W_{f}=[w_{frequency,1}, w_{frequency,2}, . . . , w_{frequency,N}_{ₜᵢₘₑ}], and a coefficient matrix \tilde{W}_{2,n}. The network entity 105-a may extract an element associated with a position (i, j) from all of the coefficient matrix {\tilde{W}_{2,n}}, which may result in a time domain vector w^{(i,j)}=[w₁^{(i,j)}, w₂^{(i,j)}, . . . w_{N}^{(i,j)}]. The network entity 105-a may then perform a transformation (e.g., discrete Fourier transform (DFT)) to the time domain vector, which may result in a Doppler domain spectrum z^{(i,j)}(f). In some cases, major values in the Doppler domain spectrum z^{(i,j)}(f) with the largest powers are used as Doppler frequency values (denoted as f_{D,l}) indexed by l=1˜L, such that a time domain precoding matrix may be represented by Equation 2 and Equation 3:

$${W}_{t} = [ {w}_{time , 1} , {w}_{time , 2} ⋯ , {w}_{time , {N}_{time}} ] \qquad Equation 2$$

$${w}_{time , l} = {[ 1 , {e}^{j 2 π {f}_{D , l} {T}_{slot}} , ⋯ , {e}^{j 2 π {f}_{D , l} {T}_{slot} ( N - 1 )} ]}^{T} \qquad Equation 3$$

The network entity 105-a may determine multiple triplets (x, y, z)=(w_{spatial,x}, w_{frequency,y}, w_{time,z}), x=1˜X, y=1˜y, z=1˜z, and apply each triplet to precode one or more reference signal resources/ports (e.g., reference signals 210) in multiple slots.

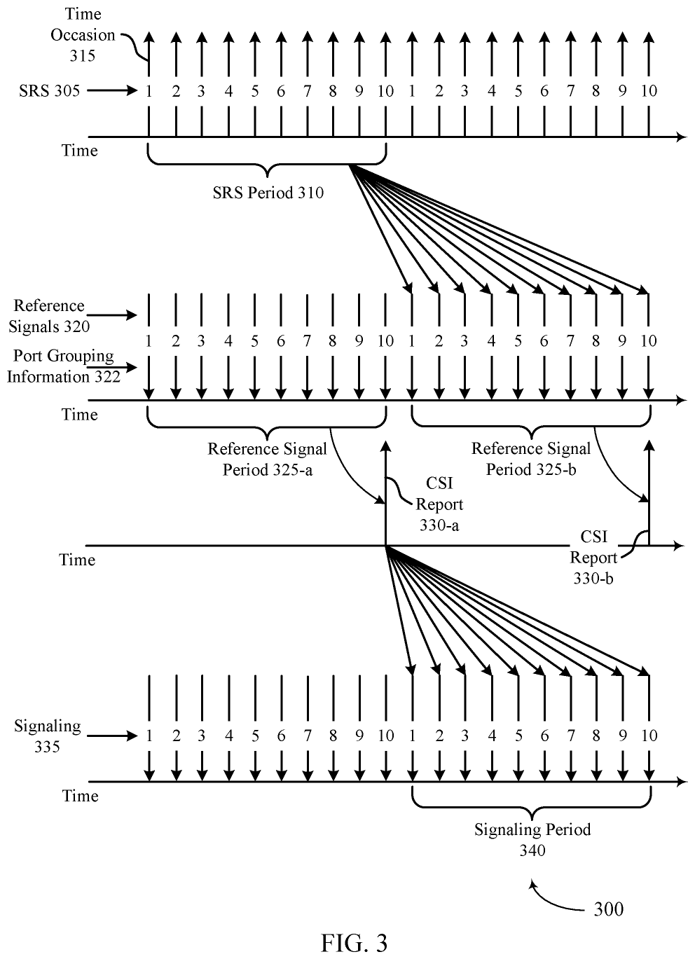

In some cases, the network entity 105-a may transmit or output, to the UE 115-a, multiple resources (e.g., ports) of the reference signals 210 (e.g., a CSI-RS, a TRS, among other examples) that are precoded by the determined three dimensional precoding weights. Additionally, the network entity 105-a may output, to the UE 115-a, one or more control signals (e.g., RRC, MAC-CE, DCI, etc.) that indicates reference signal resource grouping information 215 (e.g., three dimensional port grouping information). The three dimensional port grouping information may include multiple groups (e.g., groupings of different types), where resources (e.g., ports) of a group are precoded with identical or different spatial, frequency, and/or time domain weights, as described herein with reference to FIG. 3. Because of time domain precoding, in some cases, the network entity 105-a may output (e.g., transmit) each port in multiple slots.

In some examples, the UE 115-a may receive the precoded reference signals 210 and the resource grouping information 215. The UE 115-a may select one or more resources (e.g., ports) of the reference signals 210 to determine a channel metric (e.g., port combination coefficients) based on the indicated reference signal resource grouping information (e.g., the three dimensional port grouping information). In some cases, the UE 115-a may select the ports based on a number of grouping types indicated by the resource grouping information 215. As described in further detail herein, a grouping type may indicate to whether each of the three domains are precoded using different weights or the same precoding weights. If the resource grouping information 215 indicates a single grouping type, then the UE 115-a may select the ports for each group of that type and report channel metrics associated with the selected ports (e.g., the indexes of the selected ports and their coefficients) via a channel metric indication 220 (e.g., a CSI report). If the resource grouping message 215 indicates multiple grouping types, then the UE 115-a may select one grouping type to feed back to the network entity 105-a and indicate which grouping type was used. For example, if the network entity 105-a configures a per-group number (e.g., N_{per-group}) of selected ports, then the UE 115-a may select N_{per-group} ports for each group to report. Additionally, or alternatively, if the network entity 105-a configures a total number (e.g., Nₜₒₜₐₗ) of selected ports, then the UE 115-a may select Nₜₒₜₐₗ ports for all groups to report. In some cases, the UE 115-a may additionally indicate a quantity of selected ports in each group.

The UE 115-a may determine the channel metric (e.g., coefficients) for a multi-port group (e.g., a single-port group may exclude a coefficient). For example, the UE 115-a may estimate, for each group of ports, one or more channel matrixes (e.g., {\tilde{h}_{n,k,p}}_{n=1˜N,k=1˜K,p=1˜N}_{ₚ}) for the slots in which the reference signals 210 are received. In some cases, the UE 115-a may determine coefficients (e.g., αₚ) for each port. For example, the UE 115-a may determine αₚ such that vectors (e.g., [g_{1,k}, g_{2,k}, . . . , g_{N,k}]) have a minimum time variance factor and a maximum power, which may be represented by Equation 4:

$${g}_{n , k} = {\sum }_{p = 1}^{{N}_{p}} {α}_{p} {\tilde{h}}_{n , k , p} . \qquad Equation 4$$

In some examples, the time variance of a vector may be expressed as performing DFT to the vector (e.g., resulting in [F_{1,k}, F_{2,k}, . . . , F_{N,k}]). By performing DFT to the vector, the power ratio between all of the non-first element(s) over the first element is regarded as a time variance factor. In some cases, if g_{n,k} is a per-subband value, then the UE 115-a may determine the coefficients αₚ for a certain wideband metric (e.g., for averaging time variance situations and powers over all the subbands).

In some cases, the UE 115-a may transmit (e.g., report) the channel metric indication 220 (e.g., the result of port selection and coefficients) to the network entity 105-a based on the selected one or more resources of the reference signals 210 and the determined channel metric. For example, the channel metric indication 220 may include the per-group port selection result and the per-port coefficients (e.g., {αₚ}ₚ₌₁^{N}^{ₚ}). In some cases, a feedback overhead associated with the selecting, determining, and transmitting process may be smaller (e.g., much smaller) than a method that relies on a Doppler frequency report, by the UE 115-a, as described herein with reference to FIG. 1.

In some examples, based on the channel metric indication 220 (e.g., feedback), the network entity 105-a may determine one or more precoding weights (e.g., three dimensional precoding weights) for subsequent slots (e.g., the following slots). For example, the network entity 105-a may determine individual precoding weights for each of the following slots based on the channel metric indication 220 (e.g., a report from the UE 115-a). The channel metric indication 220 (e.g., UE 115-a feedback) may include indexes of multiple ports and coefficients associated with the multiple ports, where each port may correspond to a triplet (e.g., (w_{spatial,x}, w_{frequency,y}, w_{time,z})). If two or more triplets (denoted as P) include identical spatial (e.g., w_{spatial,x}) and frequency (e.g., w_{frequency,y}) values, then the time domain precoding weight for slot n may be equal to Equation 5:

$${\tilde{w}}_{time , n}^{( x , y )} = {\sum }_{p = 1}^{P} {α}_{p} {e}^{j 2 π {f}_{D , l} {T}_{slot} n} \qquad Equation 5$$

(e.g., when using the spatial domain precoding and the frequency domain precoding) Thus, network entity 105-a may determine the three dimensional precoding weight matrix for slot n according to Equation 6:

$$[ {w}_{spatial , 1} , ⋯ , {w}_{spatial , {N}_{t}} ] [ \begin{matrix}{\tilde{w}}_{time , n}^{( 1 , 1 )} & ⋯ & {\tilde{w}}_{time , n}^{( 1 , {N}_{f} )} \\ ⋮ & ⋱ & ⋮ \\ {\tilde{w}}_{time , n}^{( {N}_{t} , 1 )} & ⋯ & {\tilde{w}}_{time , n}^{( {N}_{t} , {N}_{f} )}\end{matrix} ] [ \begin{matrix}{w}_{frequency , 1}^{H} \\ ⋮ \\ {w}_{frequency , {N}_{f}}^{H}\end{matrix} ] \qquad Equation 6$$

In some cases, the network entity 105-a may determine the individual precoding weights due to a time variance of the channel, as described herein with reference to FIG. 1.

FIG. 3 illustrates an example of a timeline 300 that supports resource grouping information indication for time-domain channel reporting and resource selection in accordance with one or more aspects of the present disclosure. In some examples, the timeline 300 may be implemented by aspects of the wireless communications systems 100 and 200 as described with reference to FIGS. 1 and 2, respectively. For example, the timeline 300 may be implemented by a network entity 105 and a UE 115 as described with reference to FIGS. 1 and 2. In the following description of the timeline 300, the operations between the network entity 105 and the UE 115 may be transmitted and received (e.g., a time occasion 315 with an upward arrow may denote a UE 115 transmission (uplink) and a downward arrow may denote a UE 115 reception (downlink)) in a different order than the example order shown, or the operations performed by the network entity 105 and the UE 115 may be performed in different orders or at different times. Some operations may also be omitted from the timeline 300, and other operations may be added to the timeline 300. For example, the various periods shown may be replicated many times over as communications between the network entity 105 and the UE 115 continue.

In some cases, the UE 115 may be mobile such that channel conditions may vary between time periods. To compensate for the variance, the network entity 105 may determine precoding for transmissions based on one or more reference signals.

In some examples, a procedure for CSI reporting is described. The UE 115 may transmit an SRS 305 in multiple slots (e.g., multiple time occasions 315) over an SRS period 310 (e.g., ten time occasions 315) to the network entity 105. The network entity 105 may estimate Doppler frequency associated with the multiple time occasions 315 and determine three dimension precoding weights for one or more reference signals 320 (e.g., CSI-RS, TRS, etc.) based on the SRS 305 (e.g., downlink/uplink reciprocity), as described herein with reference to FIG. 2.

In some examples, the network entity 105 may configure resources of the reference signals 320 based on the SRS 305 transmitted by the UE 115. The configured resources may include multiple ports (denoted as Nₚ). To assist the UE 115 in selecting the precoded resources (e.g., the three dimensional precoded ports) and determining coefficients associated with the precoded resources, the network entity 105 may transmit port grouping information 322 (e.g., three dimensional port grouping information) to the UE 115. In some examples, the port grouping information 322 may indicate which of the resources (e.g., ports) have identical precoding (e.g., identical spatial, frequency, and/or time domain precoding) and which of the resources have different precoding (e.g., different spatial, frequency, and/or time precoding). For example, the resources may be grouped into various types according to the precoding of different domains. A first type (Type-1) grouping may include ports with identical spatial domain precoding weights. A second type (Type-2) grouping may include ports with identical frequency domain precoding weights. A third type (Type-3) grouping may include ports with identical time domain precoding weights. A fourth type (Type-4) grouping may include ports with identical spatial domain and frequency domain precoding weights. A fifth type (Type-5) grouping may include ports with identical spatial domain and time domain precoding weights. A sixth type (Type-6) grouping may include ports with identical spatial domain, frequency domain, and time domain precoding weights. In some cases, the Type-1, Type-2, and Type-4 groupings may be used in a high speed MIMO scenario. In some examples, the network entity 105 may indicate one or multiple grouping types in the port grouping information 322 (e.g., one time of indication). In some cases, the network entity 105 may transmit the port grouping information 322 by control signaling (e.g., RRC, MAC-CE, DCI, etc.).

Table 1 may include example precoding combinations for the reference signals 320. Using the Table 1 as an example, the network entity 105 may precode eight reference signal ports associated with the reference signals 320 with two spatial domain precoding weights, two frequency domain precoding weights, and eight time domain precoding weights. In this example, the network entity 105 may indicate, to the UE 115, one or more types of port grouping information via the port grouping information 322. For example, the network entity 105 may indicate a Type-1 grouping that includes a first group of ports 1, 2, 3, and 4 and/or a second group of ports 5, 6, 7, and 8. The network entity 105 may additionally or alternatively indicate a Type-2 grouping that includes a first group of ports 1, 2, 5, and 6 and/or a second group of ports 3, 4, 7, and 8. Additionally or alternatively, the network entity may indicate a Type-4 grouping that includes a first group of ports 1 and 2, a second group of ports 3 and 4, a third group of ports 5 and 6, and a fourth group of ports 7 and 8.

TABLE 1

| Reference | Spatial Domain | Frequency Domain | Time Domain |
|---|---|---|---|
| Signals | Precoding Weight | Precoding Weight | Precoding Weight |
| Port Index | Index | Index | Index |
| 1 | 1 | 1 | 1 |
| 2 | 1 | 1 | 2 |
| 3 | 1 | 2 | 3 |
| 4 | 1 | 2 | 4 |
| 5 | 2 | 1 | 5 |
| 6 | 2 | 1 | 6 |
| 7 | 2 | 2 | 7 |
| 8 | 2 | 2 | 8 |

It is understood that the different type groupings and precodings described herein (e.g., with reference to Table 1) represent possible type groupings and precodings, and are not to be construed as limiting to these specific examples. Various groupings and precodings may be possible beyond what is represented herein. In some cases, the group types may be preconfigured at a UE 115 or configured via control signaling (e.g., via RRC signaling).

The UE 115 may receive the reference signals 320 during the reference signal period 325-b. The reference signal period 325-b may correspond to the SRS period 310. That is, the reference signal period 325-b may include time occasions (e.g., slots) that correspond to the time occasions 315 (e.g., slots) of the SRS period 310. Similarly, the reference signal period 325-a may correspond to a SRS period prior to the SRS period 310. The time occasion/slot mapping between SRS periods and reference signal periods may support channel estimations (CSI reports) and precoding weight determination (e.g., in the time domain). The UE 115 may also receive the port grouping information 322 and generate and transmit a CSI report 330 based on the received reference signals 320 and the port grouping information 322. For example, the UE 115 may perform a port selection and determine coefficients based on the reference signals 320 and the port grouping information 322. The selected ports and coefficients may be transmitted to the network entity 105 via CSI report 330 or via another signal (e.g., UCI signaling). The network entity 105 may determine a dedicated precoding matrix for each time occasion 315 (e.g., slot) within a signaling period 340 based on the CSI report 330 (e.g., the reported port selection results), as described herein with reference to FIG. 2. The network entity 105 may output signaling 335 (e.g., downlink transmissions) based on the precoding matrix. The signaling period 340 may correspond to reference signal period 325-a and may be based on CSI report 330-a. Thus, a signaling period subsequent to signaling period 340 may include transmissions that are precoded based on the CSI report 330-b. The three dimensional precoded downlink transmissions during signaling periods (e.g., signaling period 340) may be examples of physical downlink control channel transmissions, physical downlink shared transmissions, reference signal transmissions, or any combination thereof.

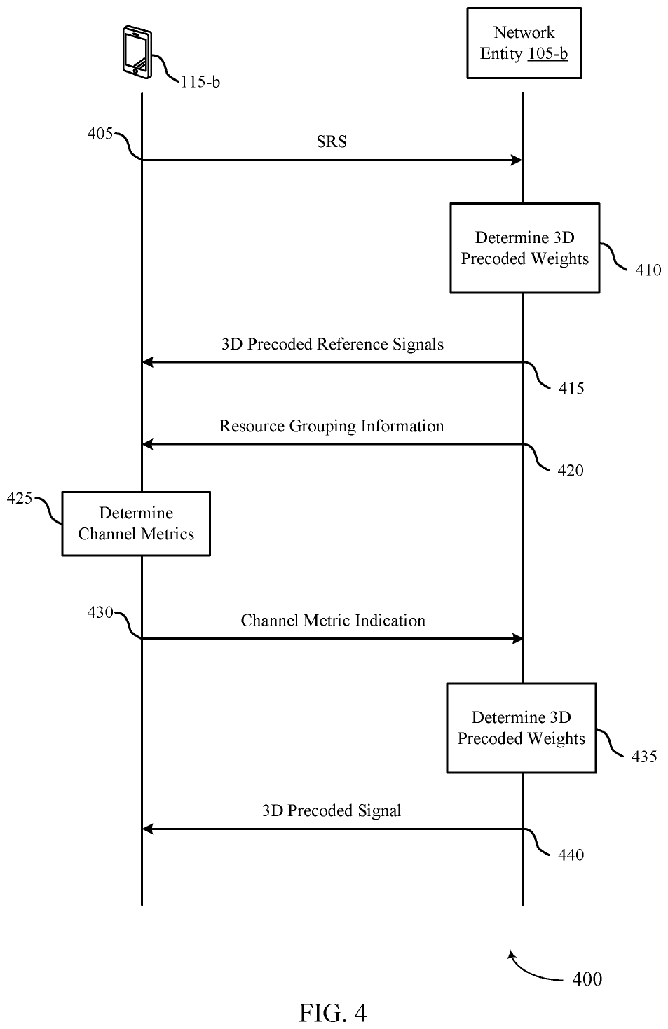

FIG. 4 illustrates an example of a process flow 400 that supports resource grouping information indication for time-domain channel reporting and resource selection in accordance with one or more aspects of the present disclosure. In some examples, the process flow 400 may implement or be implemented by aspects of the wireless communications systems 100 and 200 and the timeline 300, as described herein with reference to FIGS. 1-3. For example, the process flow 400 may be implemented by a UE 115-b and a network entity 105-b, which may be respective examples of a UE 115 and a network entity 105, as described with reference to FIGS. 1-3. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may sound one or more SRS resources during multiple first occasions (e.g., multiple slots) of a first period that precedes and corresponds to a second period that includes second occasions during which the UE 115-b may receive one or more reference signals (e.g., CSI-RS, TRS, etc.). Sounding the SRS resources may include transmitting SRSs using the SRS resources.

At 410, the network entity 105-b may determine three dimensional precoding weights based on the sounded SRS resources. For example, the network entity 105-b may derive a channel matrix for each transmission time interval (e.g., slot or transmission occasion) of a set of transmission time intervals and a number of subbands based on the sounded SRS resources. Additionally, the network entity 105-b may estimate a set of Doppler frequency values using the channel matrix for each transmission time interval and precode one or more reference signals based on the set of Doppler frequency values. The network entity 105 may also determine a set of triplets based on the SRS signaling, where each triplet may include a spatial precoding weight, a frequency precoding weight, and a time precoding weight, as described herein with reference to FIG. 2.

At 415, the network entity 105-b may transmit the one or more reference signals that are precoded in three domains and using respective reference signal resources. In some cases, the one or more reference signals may be precoded based on the set of Doppler frequency values, the set of triplets, or both. The one or more reference signals may be precoded according to three domains (e.g., time, frequency, and spatial domains).

At 420, the network entity 105-b may transmit control signaling (e.g., RRC, MAC-CE, DCI, etc.) that indicates reference signal resource grouping information. For example, the control signaling may indicate at least one group of reference signal resources (e.g., ports) and precoding information in the three domains for at least one group. The precoding information may indicate that the at least one group of reference signal resources is precoded with a same precoding weight in one or more of the three domains, a different precoding weight in the one or more domains, or a combination thereof (e.g., as in the example of Table 1). In some cases, the indicated at least one group of reference signal resources may be associated with a group type mapped to the precoding information. Thus, the resource grouping information at 420 may indicate a group type and an index of a number of ports (resources) for the indicated group type. In some cases, the indication may include multiple (e.g., two) groups of reference signal resources and precoding information in the three domains for the multiple groups.

At 425, the UE 115-b may determine a channel metric that corresponds to at least one reference signal resource. For example, the UE 115-b may determine the channel metric based on receiving and measuring the precoded reference signals and using the reference signal resource grouping information. In some cases, the UE 115-b may select reference signal resources (e.g., ports) of the one or more groups associated with one or more group types. In some examples, the channel metric may include an index associated with a port for each of the selected reference signal resources. In some cases, the UE 115-b may estimate a channel matrix, determine optimal coefficient vectors using at least one of a minimum time variance factor and a maximum power, and determine at least a channel coefficient, as part of determine the channel metric, as described herein with reference to FIG. 2.

At 430, the UE 115-b may transmit an indication of the channel metric. The UE 115-b may also indicate a channel metric for each group of the multiple groups, an indication of which reference signal resources were selected (e.g., from the one or more groups), an indication of the precoding information (e.g., a group type mapped to the precoding information), or any combination thereof. In some cases, the UE 115-b may transmit the various indications in a single message as a single indication, multiple indications, multiple messages as multiple indications, or any combination thereof. At 435, the network entity 105-b may determine precoding weights (e.g., three dimensional precoding weights) for one or more transmission time intervals based on the received channel metrics, selected ports, group types, etc. received from the UE 115. For example, the network entity 105-b may determine the precoding weights for downlink communications in subsequent slots.

At 440, the network entity 105-b may output a downlink transmission (e.g., a subsequent downlink transmission) that is precoded in the three domains based on the channel metric. In some cases, the downlink transmission may be a downlink shared channel transmission, a downlink control channel transmission, a reference signal transmission, or any combination thereof.

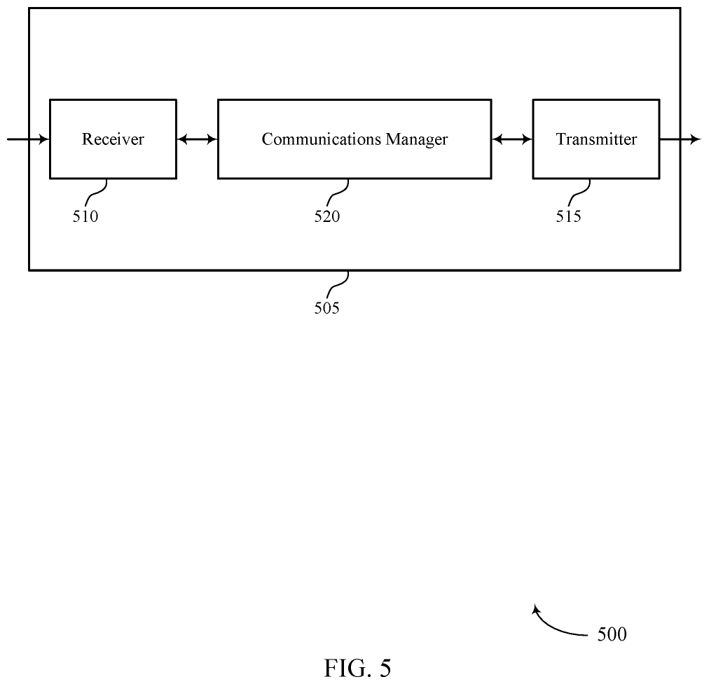

FIG. 5 shows a block diagram 500 of a device 505 that supports resource grouping information indication for time-domain channel reporting and resource selection in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to resource grouping information indication for time-domain channel reporting and resource selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource grouping information indication for time-domain channel reporting and resource selection). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of resource grouping information indication for time-domain channel reporting and resource selection as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving two or more reference signals that are precoded in three domains, where the two or more reference signals are received using respective reference signal resources. The communications manager 520 may be configured as or otherwise support a means for receiving control signaling indicating reference signal resource grouping information, where the reference signal resource grouping information specifies at least one group of reference signal resources and precoding information in the three domains for the at least one group. The communications manager 520 may be configured as or otherwise support a means for transmitting an indication of a channel metric corresponding to at least two reference signal resources, where the channel metric is determined based on measuring reference signals and the reference signal resource grouping information.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for decreased UCI overhead, increased Doppler frequency precision, and decreased UE complexity.

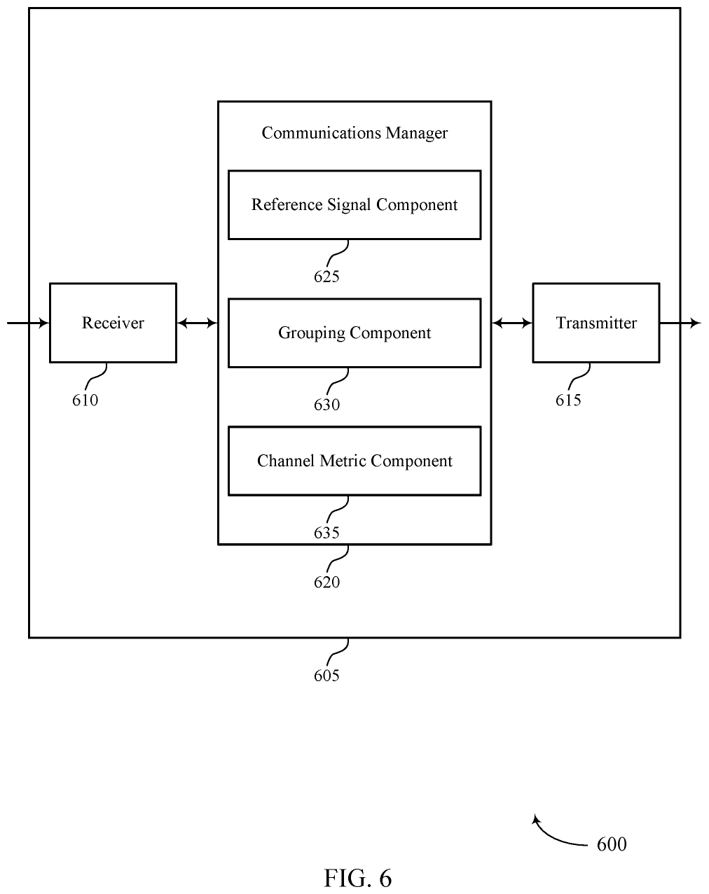

FIG. 6 shows a block diagram 600 of a device 605 that supports resource grouping information indication for time-domain channel reporting and resource selection in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to resource grouping information indication for time-domain channel reporting and resource selection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource grouping information indication for time-domain channel reporting and resource selection). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of resource grouping information indication for time-domain channel reporting and resource selection as described herein. For example, the communications manager 620 may include a reference signal component 625, a grouping component 630, a channel metric component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The reference signal component 625 may be configured as or otherwise support a means for receiving two or more reference signals that are precoded in three domains, where the two or more reference signals are received using respective reference signal resources. The grouping component 630 may be configured as or otherwise support a means for receiving control signaling indicating reference signal resource grouping information, where the reference signal resource grouping information specifies at least one group of reference signal resources and precoding information in the three domains for the at least one group. The channel metric component 635 may be configured as or otherwise support a means for transmitting an indication of a channel metric corresponding to at least two reference signal resources, where the channel metric is determined based on measuring reference signals and the reference signal resource grouping information.

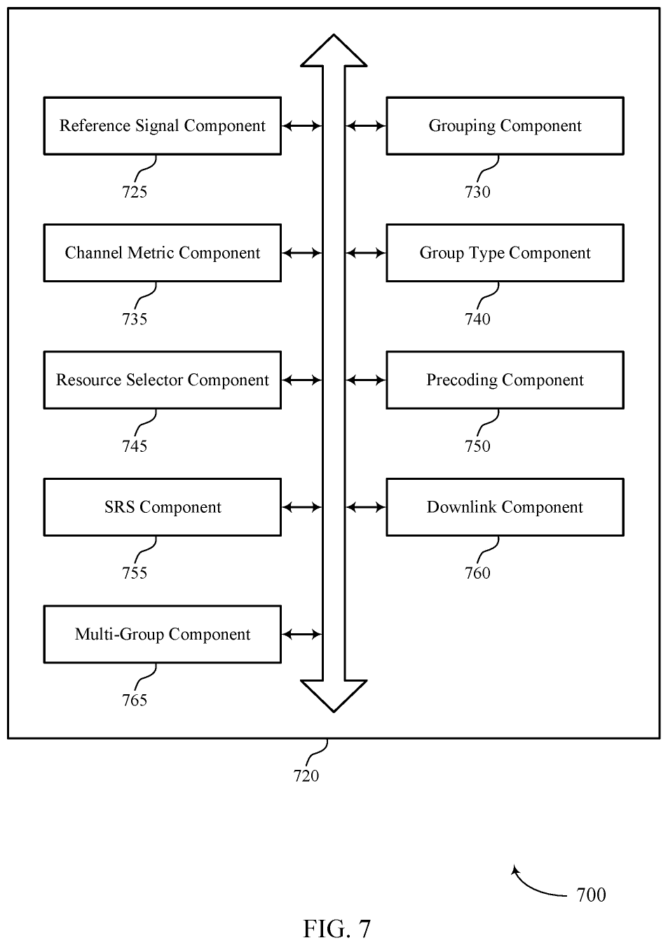

FIG. 7 shows a block diagram 700 of a communications manager 720 that supports resource grouping information indication for time-domain channel reporting and resource selection in accordance with one or more aspects of the present disclosure. The communications manager 720 may be an example of aspects of a communications manager 520, a communications manager 620, or both, as described herein. The communications manager 720, or various components thereof, may be an example of means for performing various aspects of resource grouping information indication for time-domain channel reporting and resource selection as described herein. For example, the communications manager 720 may include a reference signal component 725, a grouping component 730, a channel metric component 735, a group type component 740, a resource selector component 745, a precoding component 750, an SRS component 755, a downlink component 760, a multi-group component 765, or any combination thereof. Each of these components may communicate, directly or indirectly, with one another (e.g., via one or more buses).

The communications manager 720 may support wireless communication at a UE in accordance with examples as disclosed herein. The reference signal component 725 may be configured as or otherwise support a means for receiving two or more reference signals that are precoded in three domains, where the two or more reference signals are received using respective reference signal resources. The grouping component 730 may be configured as or otherwise support a means for receiving control signaling indicating reference signal resource grouping information, where the reference signal resource grouping information specifies at least one group of reference signal resources and precoding information in the three domains for the at least one group. The channel metric component 735 may be configured as or otherwise support a means for transmitting an indication of a channel metric corresponding to at least two reference signal resources, where the channel metric is determined based on measuring reference signals and the reference signal resource grouping information.

In some examples, to support receiving the control signaling, the grouping component 730 may be configured as or otherwise support a means for receiving the precoding information that indicates that the at least one group of reference signal resources is precoded with a same precoding weight in one or more domains of the three domains, a different precoding weight in the one or more domains, or a combination thereof.

In some examples, to support receiving the control signaling, the group type component 740 may be configured as or otherwise support a means for receiving an indication of a group type for the at least one group, where the indicated group type is mapped to the precoding information. In some examples, to support receiving the control signaling, the grouping component 730 may be configured as or otherwise support a means for receiving a radio resource control message, a medium access control layer control element, a downlink control information message, or a combination thereof, that indicates the reference signal resource grouping information.

In some examples, the resource selector component 745 may be configured as or otherwise support a means for selecting the at least two reference signal resources of the at least one group, where the channel metric is based on measuring reference signals of the at least two reference signal resources. In some examples, the resource selector component 745 may be configured as or otherwise support a means for transmitting, with the indication of the channel metric, an indication of the at least two reference signal resources.

In some examples, the indication of the at least two reference signal resources includes an index corresponding to a port for each of the at least two reference signal resources.

In some examples, to support transmitting the indication of the channel metric, the channel metric component 735 may be configured as or otherwise support a means for transmitting an indication of a reference signal resource coefficient corresponding to the at least two reference signal resources of the at least one group.

In some examples, the precoding component 750 may be configured as or otherwise support a means for transmitting an indication of the precoding information corresponding to the at least one group and the channel metric.

In some examples, to support transmitting the indication of the precoding information, the precoding component 750 may be configured as or otherwise support a means for transmitting an indication of a group type of the at least one group, where the group type is mapped to the precoding information.

In some examples, to support receiving the control signaling, the grouping component 730 may be configured as or otherwise support a means for receiving control signaling indicating the reference signal resource grouping information that specifies a first group of reference signal resources and first precoding information in the three domains for the first group and a second group of reference signal resources and second precoding information in the three domains for the second group.

In some examples, to support transmitting the indication of the channel metric, the channel metric component 735 may be configured as or otherwise support a means for transmitting the indication of the channel metric for the first group, where the channel metric is determined based on measuring the reference signals for one or more first reference signal resources of the first group. In some examples, to support transmitting the indication of the channel metric, the channel metric component 735 may be configured as or otherwise support a means for transmitting the indication of the channel metric for the second group, where the channel metric is determined based on measuring the reference signals for one or more second reference signal resources of the second group.

In some examples, the multi-group component 765 may be configured as or otherwise support a means for transmitting an indication of the one or more first reference signal resources selected for the first group. In some examples, the multi-group component 765 may be configured as or otherwise support a means for transmitting an indication of the one or more second reference signal resources selected for the second group.

In some examples, the SRS component 755 may be configured as or otherwise support a means for sounding one or more SRS resources during a set of multiple first occasions of a first period that precedes and corresponds to a second period including second occasions during which the two or more reference signals are received, where the two or more reference signals are precoded based on the one or more SRS resources and the reference signal resource grouping information is based on the one or more SRS resources.

In some examples, the three domains include a time domain, a frequency domain, and a spatial domain and the two or more reference signals include CSI-RS, TRSs, or a combination thereof.

In some examples, the downlink component 760 may be configured as or otherwise support a means for receiving a downlink transmission that is precoded in the three domains based on the indication of the channel metric, where the downlink transmission is a downlink shared channel transmission, a downlink control channel transmission, a reference signal transmission, or a combination thereof.

In some examples, the channel metric component 735 may be configured as or otherwise support a means for estimating a channel matrix for the at least one group based on measuring the reference signals of the at least one group. In some examples, the channel metric component 735 may be configured as or otherwise support a means for determining optimal coefficient vectors using at least one of a minimum time variance factor and a maximum power based on the channel matrix. In some examples, the channel metric component 735 may be configured as or otherwise support a means for determining at least channel coefficient for the at least one group.

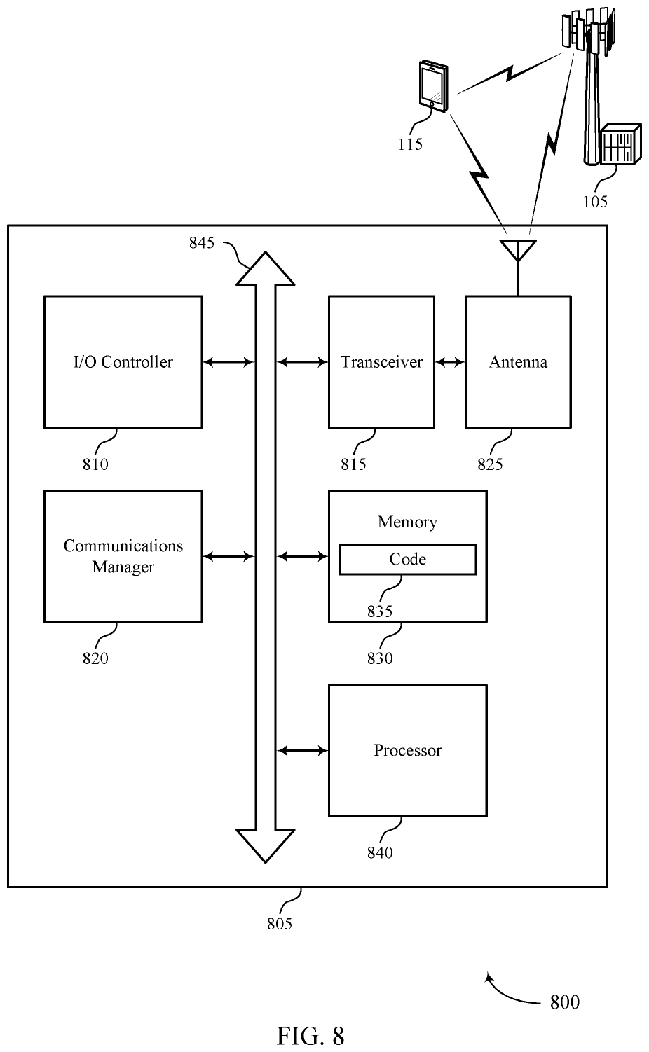

FIG. 8 shows a diagram of a system 800 including a device 805 that supports resource grouping information indication for time-domain channel reporting and resource selection in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting resource grouping information indication for time-domain channel reporting and resource selection). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving two or more reference signals that are precoded in three domains, where the two or more reference signals are received using respective reference signal resources. The communications manager 820 may be configured as or otherwise support a means for receiving control signaling indicating reference signal resource grouping information, where the reference signal resource grouping information specifies at least one group of reference signal resources and precoding information in the three domains for the at least one group. The communications manager 820 may be configured as or otherwise support a means for transmitting an indication of a channel metric corresponding to at least two reference signal resources, where the channel metric is determined based on measuring reference signals and the reference signal resource grouping information.

By including or configuring the communications manager 820 in accordance with examples as described herein, the device 805 may support techniques for decreased UCI overhead, increased Doppler frequency precision, and decreased UE complexity.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of resource grouping information indication for time-domain channel reporting and resource selection as described herein, or the processor 840 and the memory 830 may be otherwise configured to perform or support such operations.

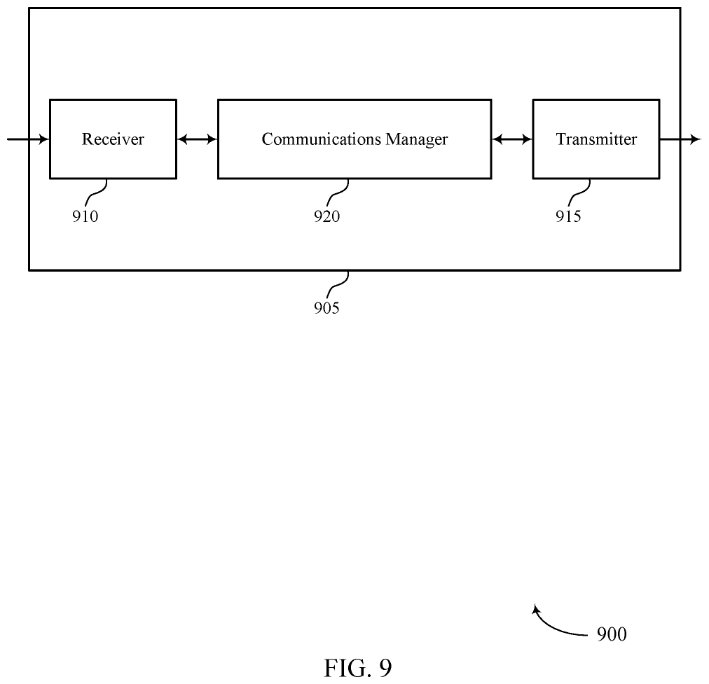

FIG. 9 shows a block diagram 900 of a device 905 that supports resource grouping information indication for time-domain channel reporting and resource selection in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of resource grouping information indication for time-domain channel reporting and resource selection as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting two or more reference signals that are precoded in three domains, where the two or more reference signals are transmitted using respective reference signal resources. The communications manager 920 may be configured as or otherwise support a means for transmitting control signaling indicating reference signal resource grouping information, where the reference signal resource grouping information specifies at least one group of reference signal resources and precoding information in the three domains for the at least one group. The communications manager 920 may be configured as or otherwise support a means for receiving, based on transmitting the two or more reference signals and the reference signal resource grouping information, an indication of a channel metric corresponding to at least two reference signal resources.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for decreased UCI overhead, increased Doppler frequency precision, and decreased UE complexity.

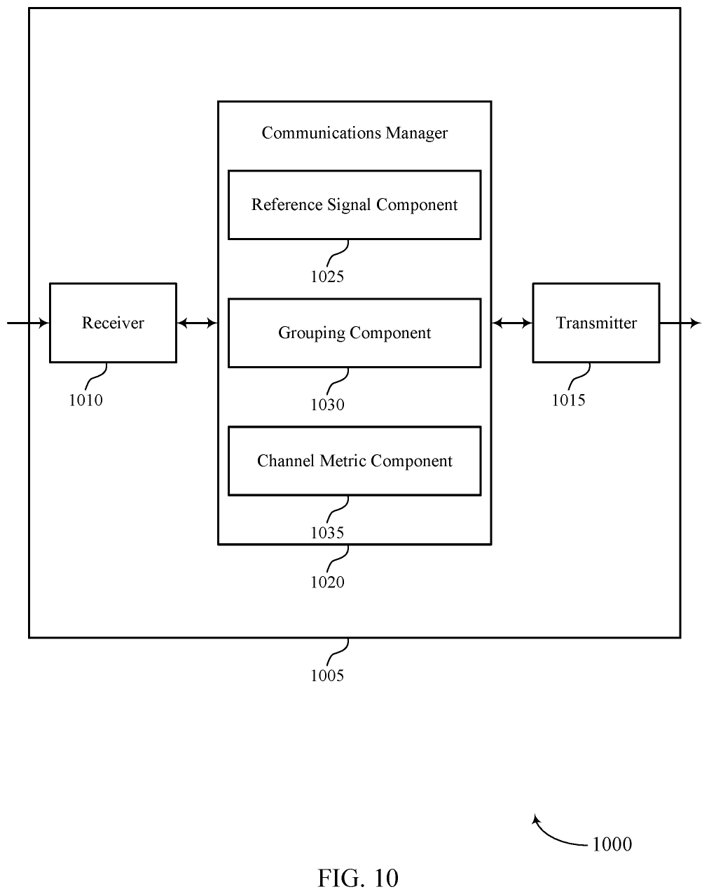

FIG. 10 shows a block diagram 1000 of a device 1005 that supports resource grouping information indication for time-domain channel reporting and resource selection in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of resource grouping information indication for time-domain channel reporting and resource selection as described herein. For example, the communications manager 1020 may include a reference signal component 1025, a grouping component 1030, a channel metric component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The reference signal component 1025 may be configured as or otherwise support a means for transmitting two or more reference signals that are precoded in three domains, where the two or more reference signals are transmitted using respective reference signal resources. The grouping component 1030 may be configured as or otherwise support a means for transmitting control signaling indicating reference signal resource grouping information, where the reference signal resource grouping information specifies at least one group of reference signal resources and precoding information in the three domains for the at least one group. The channel metric component 1035 may be configured as or otherwise support a means for receiving, based on transmitting the two or more reference signals and the reference signal resource grouping information, an indication of a channel metric corresponding to at least two reference signal resources.

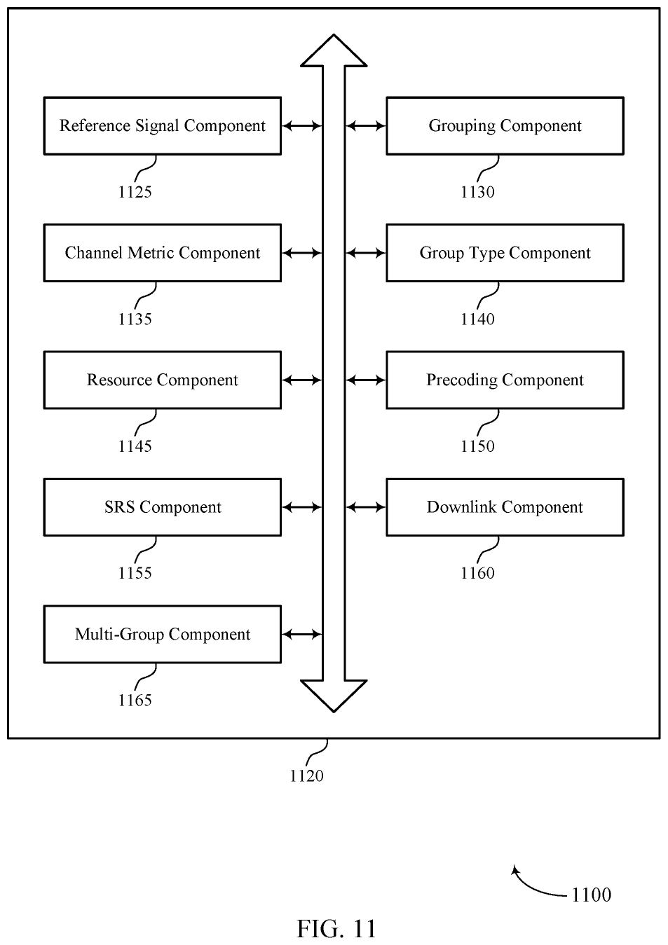

FIG. 11 shows a block diagram 1100 of a communications manager 1120 that supports resource grouping information indication for time-domain channel reporting and resource selection in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of resource grouping information indication for time-domain channel reporting and resource selection as described herein. For example, the communications manager 1120 may include a reference signal component 1125, a grouping component 1130, a channel metric component 1135, a group type component 1140, a resource component 1145, a precoding component 1150, an SRS component 1155, a downlink component 1160, a multi-group component 1165, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The reference signal component 1125 may be configured as or otherwise support a means for transmitting two or more reference signals that are precoded in three domains, where the two or more reference signals are transmitted using respective reference signal resources. The grouping component 1130 may be configured as or otherwise support a means for transmitting control signaling indicating reference signal resource grouping information, where the reference signal resource grouping information specifies at least one group of reference signal resources and precoding information in the three domains for the at least one group. The channel metric component 1135 may be configured as or otherwise support a means for receiving, based on transmitting the two or more reference signals and the reference signal resource grouping information, an indication of a channel metric corresponding to at least two reference signal resources.

In some examples, to support transmitting the control signaling, the grouping component 1130 may be configured as or otherwise support a means for transmitting the precoding information that indicates that the at least one group of reference signal resources is precoded with a same precoding weight in one or more domains of the three domains, a different precoding weight in the one or more domains, or a combination thereof.

In some examples, to support transmitting the control signaling, the group type component 1140 may be configured as or otherwise support a means for transmitting an indication of a group type for the at least one group, where the indicated group type is mapped to the precoding information. In some examples, to support transmitting the control signaling, the grouping component 1130 may be configured as or otherwise support a means for transmitting a radio resource control message, a medium access control layer control element, a downlink control information message, or a combination thereof, that indicates the reference signal resource grouping information.

In some examples, the resource component 1145 may be configured as or otherwise support a means for receiving, with the indication of the channel metric, an indication of the at least two reference signal resources that were used to determine the channel metric.

In some examples, the indication of the at least two reference signal resources includes an index corresponding to a port for each of the at least two reference signal resources.

In some examples, to support receiving the indication of the channel metric, the channel metric component 1135 may be configured as or otherwise support a means for receiving an indication of a reference signal resource coefficient corresponding to the at least two reference signal resources of the at least one group.

In some examples, to support transmitting the control signaling, the precoding component 1150 may be configured as or otherwise support a means for transmitting the control signaling indicating the reference signal resource grouping information that specifies a first group of reference signal resources and first precoding information in the three domains for the first group and a second group of reference signal resources and second precoding information in the three domains for the second group.

In some examples, to support receiving the indication of the channel metric, the channel metric component 1135 may be configured as or otherwise support a means for receiving the indication of the channel metric for the first group. In some examples, to support receiving the indication of the channel metric, the channel metric component 1135 may be configured as or otherwise support a means for receiving the indication of the channel metric for the second group.

In some examples, the multi-group component 1165 may be configured as or otherwise support a means for receiving an indication of one or more first reference signal resources selected for the first group. In some examples, the multi-group component 1165 may be configured as or otherwise support a means for receiving an indication of one or more second reference signal resources selected for the second group.

In some examples, the SRS component 1155 may be configured as or otherwise support a means for receiving one or more SRSs during a set of multiple first occasions of a first period that precedes and corresponds to a second period including second periods during which the two or more reference signals are transmitted, where the two or more reference signals are precoded based on the received one or more SRSs.

In some examples, the precoding component 1150 may be configured as or otherwise support a means for deriving a channel matrix for each transmission time interval of a set of transmission time intervals and for a number of subbands based on the one or more SRSs. In some examples, the precoding component 1150 may be configured as or otherwise support a means for estimating a set of Doppler frequency values using the channel matrix for each transmission time interval. where the two or more reference signals are precoded based on the set of Doppler frequency values. In some examples, the precoding component 1150 may be configured as or otherwise support a means for determining a set of triplets based on the one or more SRSs, where each triplet includes a spatial precoding weight, a frequency precoding weight, and a time precoding weight, where the set of triplets are applied for transmitting the at least two reference signals.

In some examples, the three domains include a time domain, a frequency domain, and a spatial domain and the two or more reference signals include CSI-RS, TRSs, or a combination thereof.

In some examples, the precoding component 1150 may be configured as or otherwise support a means for determining precoding weights for one or more transmission time intervals based on the channel metric. In some examples, the downlink component 1160 may be configured as or otherwise support a means for transmitting a downlink transmission that is precoded in the three domains based on the channel metric, where the downlink transmission is a downlink shared channel transmission, a downlink control channel transmission, a reference signal transmission, or a combination thereof.

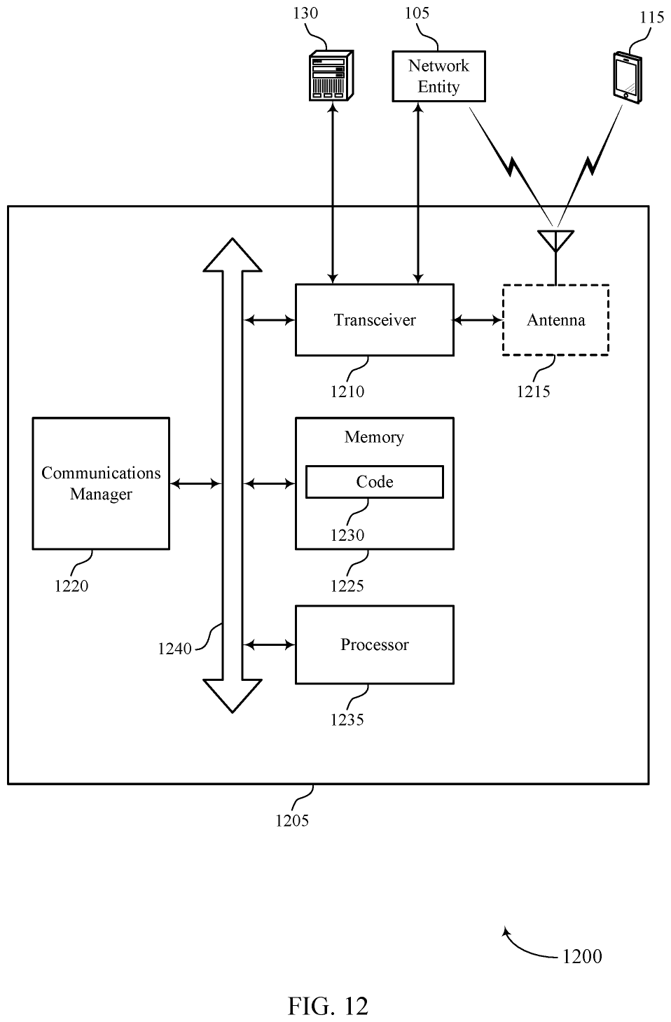

FIG. 12 shows a diagram of a system 1200 including a device 1205 that supports resource grouping information indication for time-domain channel reporting and resource selection in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting resource grouping information indication for time-domain channel reporting and resource selection). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting two or more reference signals that are precoded in three domains, where the two or more reference signals are transmitted using respective reference signal resources. The communications manager 1220 may be configured as or otherwise support a means for transmitting control signaling indicating reference signal resource grouping information, where the reference signal resource grouping information specifies at least one group of reference signal resources and precoding information in the three domains for the at least one group. The communications manager 1220 may be configured as or otherwise support a means for receiving, based on transmitting the two or more reference signals and the reference signal resource grouping information, an indication of a channel metric corresponding to at least two reference signal resources.

By including or configuring the communications manager 1220 in accordance with examples as described herein, the device 1205 may support techniques for decreased UCI overhead, increased Doppler frequency precision, and decreased UE complexity.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of resource grouping information indication for time-domain channel reporting and resource selection as described herein, or the processor 1235 and the memory 1225 may be otherwise configured to perform or support such operations.

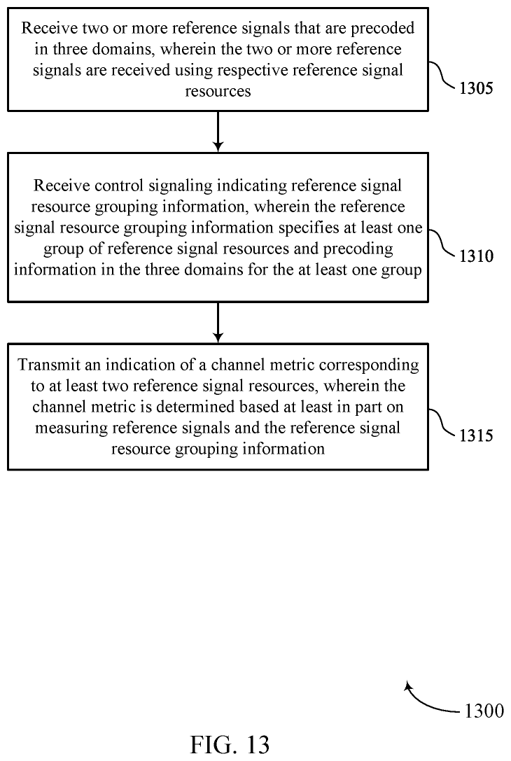

FIG. 13 shows a flowchart illustrating a method 1300 that supports resource grouping information indication for time-domain channel reporting and resource selection in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving two or more reference signals that are precoded in three domains, where the two or more reference signals are received using respective reference signal resources. The operations of 1305 may be performed in accordance with examples as disclosed herein. In some examples, aspects of the operations of 1305 may be performed by a reference signal component 725 as described with reference to FIG. 7.

At 1310, the method may include receiving control signaling indicating reference signal resource grouping information, where the reference signal resource grouping information specifies at least one group of reference signal resources and precoding information in the three domains for the at least one group. The operations of 1310 may be performed in accordance with examples as disclosed herein. In some examples, aspects of the operations of 1310 may be performed by a grouping component 730 as described with reference to FIG. 7.

At 1315, the method may include transmitting an indication of a channel metric corresponding to at least two reference signal resources, where the channel metric is determined based on measuring reference signals and the reference signal resource grouping information. The operations of 1315 may be performed in accordance with examples as disclosed herein. In some examples, aspects of the operations of 1315 may be performed by a channel metric component 735 as described with reference to FIG. 7.

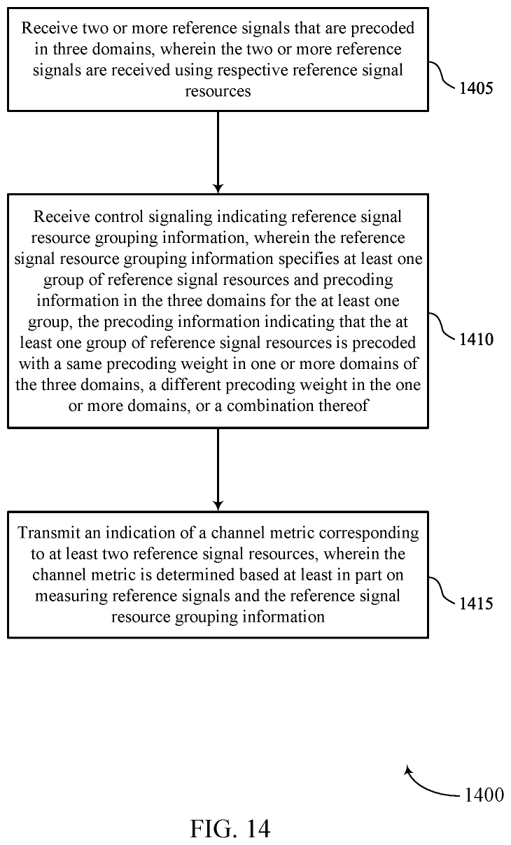

FIG. 14 shows a flowchart illustrating a method 1400 that supports resource grouping information indication for time-domain channel reporting and resource selection in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving two or more reference signals that are precoded in three domains, where the two or more reference signals are received using respective reference signal resources. The operations of 1405 may be performed in accordance with examples as disclosed herein. In some examples, aspects of the operations of 1405 may be performed by a reference signal component 725 as described with reference to FIG. 7.

At 1410, the method may include receiving control signaling indicating reference signal resource grouping information, where the reference signal resource grouping information specifies at least one group of reference signal resources and precoding information in the three domains for the at least one group, the precoding information indicating that the at least one group of reference signal resources is precoded with a same precoding weight in one or more domains of the three domains, a different precoding weight in the one or more domains, or a combination thereof. The operations of 1410 may be performed in accordance with examples as disclosed herein. In some examples, aspects of the operations of 1410 may be performed by a grouping component 730 as described with reference to FIG. 7.

At 1415, the method may include transmitting an indication of a channel metric corresponding to at least two reference signal resources, where the channel metric is determined based on measuring reference signals and the reference signal resource grouping information. The operations of 1415 may be performed in accordance with examples as disclosed herein. In some examples, aspects of the operations of 1415 may be performed by a channel metric component 735 as described with reference to FIG. 7.

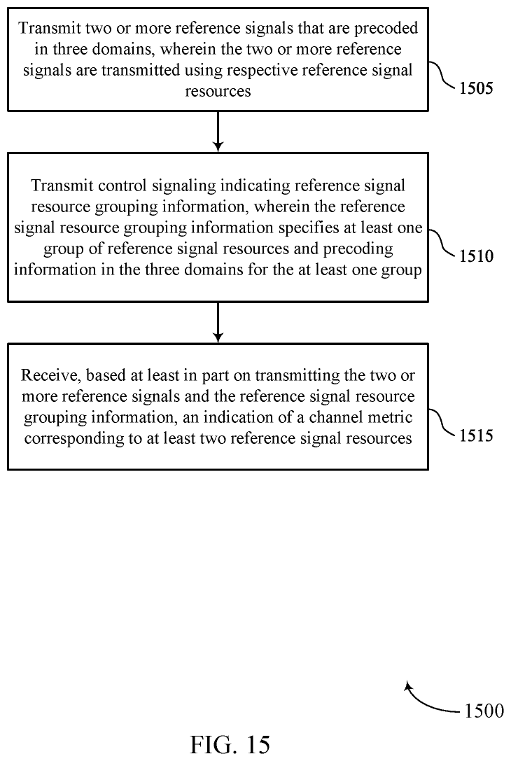

FIG. 15 shows a flowchart illustrating a method 1500 that supports resource grouping information indication for time-domain channel reporting and resource selection in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting two or more reference signals that are precoded in three domains, where the two or more reference signals are transmitted using respective reference signal resources. The operations of 1505 may be performed in accordance with examples as disclosed herein. In some examples, aspects of the operations of 1505 may be performed by a reference signal component 1125 as described with reference to FIG. 11.

At 1510, the method may include transmitting control signaling indicating reference signal resource grouping information, where the reference signal resource grouping information specifies at least one group of reference signal resources and precoding information in the three domains for the at least one group. The operations of 1510 may be performed in accordance with examples as disclosed herein. In some examples, aspects of the operations of 1510 may be performed by a grouping component 1130 as described with reference to FIG. 11.

At 1515, the method may include receiving, based on transmitting the two or more reference signals and the reference signal resource grouping information, an indication of a channel metric corresponding to at least two reference signal resources. The operations of 1515 may be performed in accordance with examples as disclosed herein. In some examples, aspects of the operations of 1515 may be performed by a channel metric component 1135 as described with reference to FIG. 11.

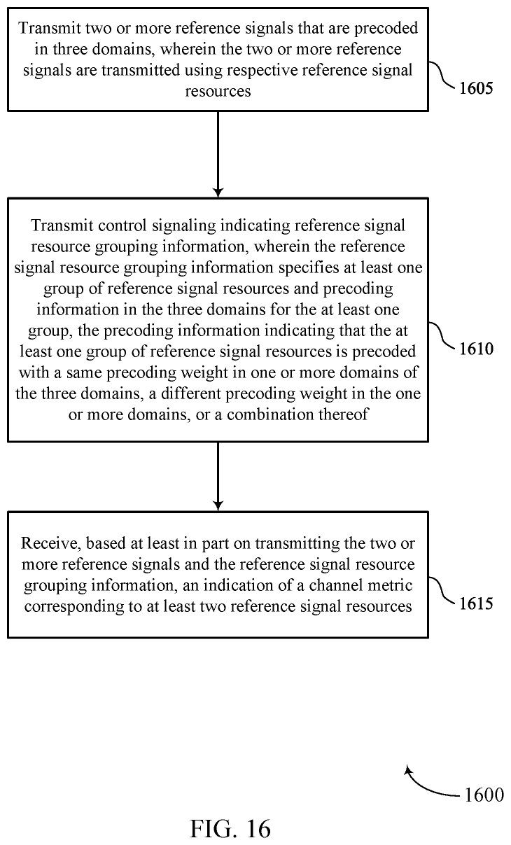

FIG. 16 shows a flowchart illustrating a method 1600 that supports resource grouping information indication for time-domain channel reporting and resource selection in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting two or more reference signals that are precoded in three domains, where the two or more reference signals are transmitted using respective reference signal resources. The operations of 1605 may be performed in accordance with examples as disclosed herein. In some examples, aspects of the operations of 1605 may be performed by a reference signal component 1125 as described with reference to FIG. 11.

At 1610, the method may include transmitting control signaling indicating reference signal resource grouping information, where the reference signal resource grouping information specifies at least one group of reference signal resources and precoding information in the three domains for the at least one group, the precoding information indicating that the at least one group of reference signal resources is precoded with a same precoding weight in one or more domains of the three domains, a different precoding weight in the one or more domains, or a combination thereof. The operations of 1610 may be performed in accordance with examples as disclosed herein. In some examples, aspects of the operations of 1610 may be performed by a grouping component 1130 as described with reference to FIG. 11.

At 1615, the method may include receiving, based on transmitting the two or more reference signals and the reference signal resource grouping information, an indication of a channel metric corresponding to at least two reference signal resources. The operations of 1615 may be performed in accordance with examples as disclosed herein. In some examples, aspects of the operations of 1615 may be performed by a channel metric component 1135 as described with reference to FIG. 11.

The following provides an overview of aspects of the present disclosure:

Aspect 1: A method for wireless communication at a UE, comprising: receiving two or more reference signals that are precoded in three domains, wherein the two or more reference signals are received using respective reference signal resources; receiving control signaling indicating reference signal resource grouping information, wherein the reference signal resource grouping information specifies at least one group of reference signal resources and precoding information in the three domains for the at least one group; and transmitting an indication of a channel metric corresponding to at least two reference signal resources, wherein the channel metric is determined based at least in part on measuring reference signals and the reference signal resource grouping information.

Aspect 2: The method of aspect 1, wherein receiving the control signaling comprises: receiving the precoding information that indicates that the at least one group of reference signal resources is precoded with a same precoding weight in one or more domains of the three domains, a different precoding weight in the one or more domains, or a combination thereof.

Aspect 3: The method of any of aspects 1 through 2, wherein receiving the control signaling comprises: receiving an indication of a group type for the at least one group, wherein the indicated group type is mapped to the precoding information; and receiving a radio resource control message, a medium access control layer control element, a downlink control information message, or a combination thereof, that indicates the reference signal resource grouping information.

Aspect 4: The method of any of aspects 1 through 3, further comprising: selecting the at least two reference signal resources of the at least one group, wherein the channel metric is based at least in part on measuring reference signals of the at least two reference signal resources; and transmitting, with the indication of the channel metric, an indication of the at least two reference signal resources.

Aspect 5: The method of aspect 4, wherein the indication of the at least two reference signal resources comprises an index corresponding to a port for each of the at least two reference signal resources.

Aspect 6: The method of any of aspects 1 through 5, wherein transmitting the indication of the channel metric comprises: transmitting an indication of a reference signal resource coefficient corresponding to the at least two reference signal resources of the at least one group.

Aspect 7: The method of any of aspects 1 through 6, further comprising: transmitting an indication of the precoding information corresponding to the at least one group and the channel metric.

Aspect 8: The method of aspect 7, wherein transmitting the indication of the precoding information comprises: transmitting an indication of a group type of the at least one group, wherein the group type is mapped to the precoding information.

Aspect 9: The method of any of aspects 1 through 8, wherein receiving the control signaling comprises: receiving the control signaling indicating the reference signal resource grouping information that specifies a first group of reference signal resources and first precoding information in the three domains for the first group and a second group of reference signal resources and second precoding information in the three domains for the second group.

Aspect 10: The method of aspect 9, wherein transmitting the indication of the channel metric comprises: transmitting the indication of the channel metric for the first group, wherein the channel metric is determined based at least in part on measuring the reference signals for one or more first reference signal resources of the first group; and transmitting the indication of the channel metric for the second group, wherein the channel metric is determined based at least in part on measuring the reference signals for one or more second reference signal resources of the second group.

Aspect 11: The method of aspect 10, further comprising: transmitting an indication of the one or more first reference signal resources selected for the first group; and transmitting an indication of the one or more second reference signal resources selected for the second group.

Aspect 12: The method of any of aspects 1 through 11, further comprising: sounding one or more SRS resources during a plurality of first occasions of a first period that precedes and corresponds to a second period including second occasions during which the two or more reference signals are received, wherein the two or more reference signals are precoded based at least in part on the one or more SRS resources and the reference signal resource grouping information is based at least in part on the one or more SRS resources.

Aspect 13: The method of any of aspects 1 through 12, wherein the three domains comprise a time domain, a frequency domain, and a spatial domain and the two or more reference signals comprise CSI reference signals, TRSs, or a combination thereof.

Aspect 14: The method of any of aspects 1 through 13, further comprising: receiving a downlink transmission that is precoded in the three domains based at least in part on the indication of the channel metric, wherein the downlink transmission is a downlink shared channel transmission, a downlink control channel transmission, a reference signal transmission, or a combination thereof.

Aspect 15: The method of any of aspects 1 through 14, further comprising: estimating a channel matrix for the at least one group based at least in part on measuring the reference signals of the at least one group; determining optimal coefficient vectors using a minimum time variance factor and a maximum power based at least in part on the channel matrix; and determining at least channel coefficient for the at least one group.

Aspect 16: A method for wireless communication at a network entity, comprising: transmitting two or more reference signals that are precoded in three domains, wherein the two or more reference signals are transmitted using respective reference signal resources; transmitting control signaling indicating reference signal resource grouping information, wherein the reference signal resource grouping information specifies at least one group of reference signal resources and precoding information in the three domains for the at least one group; and receiving, based at least in part on transmitting the two or more reference signals and the reference signal resource grouping information, an indication of a channel metric corresponding to at least two reference signal resources.

Aspect 17: The method of aspect 16, wherein transmitting the control signaling comprises: transmitting the precoding information that indicates that the at least one group of reference signal resources is precoded with a same precoding weight in one or more domains of the three domains, a different precoding weight in the one or more domains, or a combination thereof.

Aspect 18: The method of any of aspects 16 through 17, wherein transmitting the control signaling comprises: transmitting an indication of a group type for the at least one group, wherein the indicated group type is mapped to the precoding information; and transmitting a radio resource control message, a medium access control layer control element, a downlink control information message, or a combination thereof, that indicates the reference signal resource grouping information.

Aspect 19: The method of any of aspects 16 through 18, further comprising: receiving, with the indication of the channel metric, an indication of the at least two reference signal resources that were used to determine the channel metric.

Aspect 20: The method of aspect 19, wherein the indication of the at least two reference signal resources comprises an index corresponding to a port for each of the at least two reference signal resources.

Aspect 21: The method of any of aspects 16 through 20, wherein receiving the indication of the channel metric comprises: receiving an indication of a reference signal resource coefficient corresponding to the at least two reference signal resources of the at least one group.

Aspect 22: The method of any of aspects 16 through 21, wherein transmitting the control signaling comprises: transmitting the control signaling indicating the reference signal resource grouping information that specifies a first group of reference signal resources and first precoding information in the three domains for the first group and a second group of reference signal resources and second precoding information in the three domains for the second group.

Aspect 23: The method of aspect 22, wherein receiving the indication of the channel metric comprises: receiving the indication of the channel metric for the first group; and receiving the indication of the channel metric for the second group.

Aspect 24: The method of aspect 23, further comprising: receiving an indication of one or more first reference signal resources selected for the first group; and receiving an indication of one or more second reference signal resources selected for the second group.

Aspect 25: The method of any of aspects 16 through 24, further comprising: receiving one or more SRSs during a plurality of first occasions of a first period that precedes and corresponds to a second period including second periods during which the two or more reference signals are transmitted, wherein the two or more reference signals are precoded based at least in part on the received one or more SRSs.

Aspect 26: The method of aspect 25, further comprising: deriving a channel matrix for each transmission time interval of a set of transmission time intervals and for a number of subbands based at least in part on the one or more SRSs; estimating a set of doppler frequency values using the channel matrix for each transmission time interval, wherein the two or more reference signals are precoded based at least in part on the set of doppler frequency values; and determining a set of triplets based at least in part on the one or more SRSs, wherein each triplet includes a spatial precoding weight, a frequency precoding weight, and a time precoding weight, wherein the set of triplets are applied for transmitting the at least two reference signals.

Aspect 27: The method of any of aspects 16 through 26, wherein the three domains comprise a time domain, a frequency domain, and a spatial domain and the two or more reference signals comprise CSI reference signals, TRSs, or a combination thereof.

Aspect 28: The method of any of aspects 16 through 27, further comprising: determining precoding weights for one or more transmission time intervals based at least in part on the channel metric; and transmitting a downlink transmission that is precoded in the three domains based at least in part on the channel metric, wherein the downlink transmission is a downlink shared channel transmission, a downlink control channel transmission, a reference signal transmission, or a combination thereof.

Aspect 29: An apparatus for wireless communication at a UE, comprising a processor; memory coupled with the processor; and instructions stored in the memory and executable by the processor to cause the apparatus to perform a method of any of aspects 1 through 15.

Aspect 30: An apparatus for wireless communication at a UE, comprising at least one means for performing a method of any of aspects 1 through 15.

Aspect 31: A non-transitory computer-readable medium storing code for wireless communication at a UE, the code comprising instructions executable by a processor to perform a method of any of aspects 1 through 15.

Aspect 32: An apparatus for wireless communication at a network entity, comprising a processor; memory coupled with the processor; and instructions stored in the memory and executable by the processor to cause the apparatus to perform a method of any of aspects 16 through 28.

Aspect 33: An apparatus for wireless communication at a network entity, comprising at least one means for performing a method of any of aspects 16 through 28.

Aspect 34: A non-transitory computer-readable medium storing code for wireless communication at a network entity, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive two or more reference signals that are precoded in three domains, wherein the two or more reference signals are received using respective reference signal resources;
receive control signaling indicating reference signal resource grouping information, wherein the reference signal resource grouping information specifies at least one group of reference signal resources and precoding information in the three domains for the at least one group; and
transmit an indication of a channel metric corresponding to at least two reference signal resources, wherein the channel metric is determined based at least in part on measuring reference signals and the reference signal resource grouping information.

2. The apparatus of claim 1, wherein the instructions to receive the control signaling are executable by the processor to cause the apparatus to:
receive the precoding information that indicates that the at least one group of reference signal resources is precoded with a same precoding weight in one or more domains of the three domains, a different precoding weight in the one or more domains, or a combination thereof.

3. The apparatus of claim 1, wherein the instructions to receive the control signaling are executable by the processor to cause the apparatus to:
receive an indication of a group type for the at least one group, wherein the indicated group type is mapped to the precoding information; and
receive a radio resource control message, a medium access control layer control element, a downlink control information message, or a combination thereof, that indicates the reference signal resource grouping information.

4. The apparatus of claim 1, wherein the instructions are further executable by the processor to cause the apparatus to:
select the at least two reference signal resources of the at least one group, wherein the channel metric is based at least in part on measuring reference signals of the at least two reference signal resources; and
transmit, with the indication of the channel metric, an indication of the at least two reference signal resources.

5. The apparatus of claim 4, wherein the indication of the at least two reference signal resources comprises an index corresponding to a port for each of the at least two reference signal resources.

6. The apparatus of claim 1, wherein the instructions to transmit the indication of the channel metric are executable by the processor to cause the apparatus to:
transmit an indication of a reference signal resource coefficient corresponding to the at least two reference signal resources of the at least one group.

7. The apparatus of claim 1, wherein the instructions are further executable by the processor to cause the apparatus to:
transmit an indication of the precoding information corresponding to the at least one group and the channel metric.

8. The apparatus of claim 7, wherein the instructions to transmit the indication of the precoding information are executable by the processor to cause the apparatus to:
transmit an indication of a group type of the at least one group, wherein the group type is mapped to the precoding information.

9. The apparatus of claim 1, wherein the instructions to receive the control signaling are executable by the processor to cause the apparatus to:
receive control signaling indicating the reference signal resource grouping information that specifies a first group of reference signal resources and first precoding information in the three domains for the first group and a second group of reference signal resources and second precoding information in the three domains for the second group.

10. The apparatus of claim 9, wherein the instructions to transmit the indication of the channel metric are executable by the processor to cause the apparatus to:
transmit the indication of the channel metric for the first group, wherein the channel metric is determined based at least in part on measuring the reference signals for one or more first reference signal resources of the first group; and
transmit the indication of the channel metric for the second group, wherein the channel metric is determined based at least in part on measuring the reference signals for one or more second reference signal resources of the second group.

11. The apparatus of claim 10, wherein the instructions are further executable by the processor to cause the apparatus to:
transmit an indication of the one or more first reference signal resources selected for the first group; and
transmit an indication of the one or more second reference signal resources selected for the second group.

12. The apparatus of claim 1, wherein the instructions are further executable by the processor to cause the apparatus to:
sound one or more sounding reference signal resources during a plurality of first occasions of a first period that precedes and corresponds to a second period including second occasions during which the two or more reference signals are received, wherein the two or more reference signals are precoded based at least in part on the one or more sounding reference signal resources and the reference signal resource grouping information is based at least in part on the one or more sounding reference signal resources.

13. The apparatus of claim 1, wherein the three domains comprise a time domain, a frequency domain, and a spatial domain and the two or more reference signals comprise channel state information reference signals, tracking reference signals, or a combination thereof.

14. The apparatus of claim 1, wherein the instructions are further executable by the processor to cause the apparatus to:
receive a downlink transmission that is precoded in the three domains based at least in part on the indication of the channel metric, wherein the downlink transmission is a downlink shared channel transmission, a downlink control channel transmission, a reference signal transmission, or a combination thereof.

15. The apparatus of claim 1, wherein the instructions are further executable by the processor to cause the apparatus to:
estimate a channel matrix for the at least one group based at least in part on measuring the reference signals of the at least one group;
determine optimal coefficient vectors using a minimum time variance factor and a maximum power based at least in part on the channel matrix; and
determine at least channel coefficient for the at least one group.

16. An apparatus for wireless communication at a network entity, comprising:
a processor;
memory coupled with the processor; and
instructions stored in the memory and executable by the processor to cause the apparatus to:
transmit two or more reference signals that are precoded in three domains, wherein the two or more reference signals are transmitted using respective reference signal resources;
transmit control signaling indicating reference signal resource grouping information, wherein the reference signal resource grouping information specifies at least one group of reference signal resources and precoding information in the three domains for the at least one group; and
receive, based at least in part on transmitting the two or more reference signals and the reference signal resource grouping information, an indication of a channel metric corresponding to at least two reference signal resources.

17. The apparatus of claim 16, wherein the instructions to transmit the control signaling are executable by the processor to cause the apparatus to:
transmit the precoding information that indicates that the at least one group of reference signal resources is precoded with a same precoding weight in one or more domains of the three domains, a different precoding weight in the one or more domains, or a combination thereof.

18. The apparatus of claim 16, wherein the instructions to transmit the control signaling are executable by the processor to cause the apparatus to:
transmit an indication of a group type for the at least one group, wherein the indicated group type is mapped to the precoding information; and
transmit a radio resource control message, a medium access control layer control element, a downlink control information message, or a combination thereof, that indicates the reference signal resource grouping information.

19. The apparatus of claim 16, wherein the instructions are further executable by the processor to cause the apparatus to:
receive, with the indication of the channel metric, an indication of the at least two reference signal resources that were used to determine the channel metric.

20. The apparatus of claim 19, wherein the indication of the at least two reference signal resources comprises an index corresponding to a port for each of the at least two reference signal resources.

21. The apparatus of claim 16, wherein the instructions to receive the indication of the channel metric are executable by the processor to cause the apparatus to:
receive an indication of a reference signal resource coefficient corresponding to the at least two reference signal resources of the at least one group.

22. The apparatus of claim 16, wherein the instructions to transmit the control signaling are executable by the processor to cause the apparatus to:
transmit the control signaling indicating the reference signal resource grouping information that specifies a first group of reference signal resources and first precoding information in the three domains for the first group and a second group of reference signal resources and second precoding information in the three domains for the second group.

23. The apparatus of claim 22, wherein the instructions to receive the indication of the channel metric are executable by the processor to cause the apparatus to:
receive the indication of the channel metric for the first group; and
receive the indication of the channel metric for the second group.

24. The apparatus of claim 23, wherein the instructions are further executable by the processor to cause the apparatus to:
receive an indication of one or more first reference signal resources selected for the first group; and
receive an indication of one or more second reference signal resources selected for the second group.

25. The apparatus of claim 16, wherein the instructions are further executable by the processor to cause the apparatus to:
receive one or more sounding reference signals during a plurality of first occasions of a first period that precedes and corresponds to a second period including second periods during which the two or more reference signals are transmitted, wherein the two or more reference signals are precoded based at least in part on the received one or more sounding reference signals.

26. The apparatus of claim 25, wherein the instructions are further executable by the processor to cause the apparatus to:
derive a channel matrix for each transmission time interval of a set of transmission time intervals and for a number of subbands based at least in part on the one or more sounding reference signals;
estimate a set of doppler frequency values using the channel matrix for each transmission time interval, wherein the two or more reference signals are precoded based at least in part on the set of doppler frequency values; and
determine a set of triplets based at least in part on the one or more sounding reference signals, wherein each triplet includes a spatial precoding weight, a frequency precoding weight, and a time precoding weight, wherein the set of triplets are applied for transmitting the at least two reference signals.

27. The apparatus of claim 16, wherein the three domains comprise a time domain, a frequency domain, and a spatial domain and the two or more reference signals comprise channel state information reference signals, tracking reference signals, or a combination thereof.

28. The apparatus of claim 16, wherein the instructions are further executable by the processor to cause the apparatus to:
determine precoding weights for one or more transmission time intervals based at least in part on the channel metric; and
transmit a downlink transmission that is precoded in the three domains based at least in part on the channel metric, wherein the downlink transmission is a downlink shared channel transmission, a downlink control channel transmission, a reference signal transmission, or a combination thereof.

29. A method for wireless communication at a user equipment (UE), comprising:
receiving two or more reference signals that are precoded in three domains, wherein the two or more reference signals are received using respective reference signal resources;
receiving control signaling indicating reference signal resource grouping information, wherein the reference signal resource grouping information specifies at least one group of reference signal resources and precoding information in the three domains for the at least one group; and
transmitting an indication of a channel metric corresponding to at least two reference signal resources, wherein the channel metric is determined based at least in part on measuring reference signals and the reference signal resource grouping information.

30. A method for wireless communication at a network entity, comprising:
transmitting two or more reference signals that are precoded in three domains, wherein the two or more reference signals are transmitted using respective reference signal resources;
transmitting control signaling indicating reference signal resource grouping information, wherein the reference signal resource grouping information specifies at least one group of reference signal resources and precoding information in the three domains for the at least one group; and
receiving, based at least in part on transmitting the two or more reference signals and the reference signal resource grouping information, an indication of a channel metric corresponding to at least two reference signal resources.
